(19) United States
(12) Patent Application Publication
(10) Pub. No.: US 2021/0360154 A1
(43) Pub. Date: Nov. 18, 2021

(54) DISPLAY AND IMAGE-CAPTURE DEVICE

(71) Applicant: David Elliott SLOBODIN, Lake Oswego, OR (US)

(72) Inventor: David Elliott SLOBODIN, Lake Oswego, OR (US)

(21) Appl. No.: 16/874,281

(22) Filed: May 14, 2020

(51) Int. Cl. H04N 5/232; H04N 5/265; H04N 5/247

(52) U.S. Cl. CPC H04N 5/23232; H04N 5/247; H04N 5/265

(57) ABSTRACT

A display and image-capture device comprises a plurality of image sensors and a plurality of light-emitting elements disposed on a substrate. A plurality of lenses is disposed on a light-incident side of the image sensors, and the lenses are configured to direct light toward the image sensors. The image sensors may be configured to detect directional information of incident light, enabling the device to function as a plenoptic camera. In some examples, the image sensors and lenses are integrated into a plurality of microcameras.

### FIELD

This disclosure relates to systems and methods for image sensing and display. More specifically, the disclosed embodiments relate to display devices having image-capture functionality.

### INTRODUCTION

Display devices configured to show video and/or other digital data are found in a variety of settings, from personal computers to conference rooms and classrooms. In many cases, display devices include image-capture (e.g., camera) functionality, for use in videoconferencing and/or other suitable applications. However, known devices for display and image capture have various disadvantages. In some known devices, the image-sensing components are disposed at edges of the display area. This configuration can result in images that are taken from an undesirable perspective, and can lead to gaze parallax in a videoconferencing setting. In other examples, image-sensing components are integrated into the display area, but this arrangement typically limits display resolution, camera field of view, and/or other performance characteristics.

### SUMMARY

The present disclosure provides systems, apparatuses, and methods relating to devices configured for display and image capture.

In some embodiments, a method for capturing video image data comprises providing a plurality of image-sensing devices and a plurality of display pixels all embedded in a panel; receiving image display signals at the display pixels; displaying a first video image with at least a first subset of the display pixels based on the received image display signals; capturing ambient image data with the plurality of image-sensing devices; generating corrected image data by applying a correction to the captured ambient image data; receiving the corrected image data at an electronic controller; and constructing a second video image from the corrected image data with the electronic controller.

In some embodiments, a method for capturing video image data comprises providing an image-capture and display device which includes a plurality of image-sensing devices and a plurality of display pixels disposed in a common panel; capturing image data with the plurality of image-sensing devices; receiving the image data at an electronic controller; constructing a high-resolution image frame from the image data with the electronic controller; and repeating the steps of capturing image data, receiving the image data at the electronic controller, and constructing a high-resolution image frame from the image data with the electronic controller, to obtain a succession of high-resolution image frames.

In some embodiments, a method for capturing video image data comprises providing an image-capture and display device which includes a plurality of microcameras and a plurality of display pixels all disposed in a common display panel; capturing image data with the microcameras; correcting the image data by applying a correction to the image data captured by each microcamera; receiving the image data at an electronic controller; constructing a high-resolution image frame from the corrected image data with the electronic controller; repeating the steps of capturing image data, correcting the image data, receiving the image data at the electronic controller, and constructing a high-resolution image frame from the corrected image data with the electronic controller, to obtain a succession of high-resolution image frames; and displaying an image on the device with the display pixels.

Features, functions, and advantages of the present teachings may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is an isometric view of an illustrative display and image-capture device in accordance with aspects of the present disclosure.

FIG. 2 is a schematic partial top view of an illustrative substrate of the device of FIG. 1.

FIG. 3 is a schematic top view of an illustrative image-sensor die in accordance with aspects of the present disclosure.

FIG. 4 is a schematic diagram depicting the flow of data within a display and image-capture device, in accordance with aspects of the present disclosure.

FIG. 5 is a schematic partial top view depicting a plurality of lenses disposed over the substrate of FIG. 2.

FIG. 6 is a schematic partial side view of a display and image-capture device incorporating the substrate and lenses of FIG. 5.

FIG. 7 is a schematic partial side view depicting incident light impinging on the lenses of FIG. 5 from different directions.

FIG. 8 is a schematic top view depicting regions of an illustrative image-sensor die receiving light incident from the directions depicted in FIG. 7.

FIG. 9 is a schematic top view depicting illustrative image-sensor dies disposed at different locations on a device substrate.

FIG. 10 is a schematic partial side view depicting an illustrative field-stop layer of a display and image-capture device, in accordance with aspects of the present disclosure.

FIG. 11 is a schematic partial side view depicting an illustrative touch-sensitive display and image-capture device, in accordance with aspects of the present disclosure.

FIG. 12 is a schematic partial side view of another illustrative display and image-capture device, in accordance with aspects of the present disclosure.

FIG. 13 is a schematic partial side view depicting a field-stop layer and a plurality of microlenses in the device of FIG. 12.

FIG. 14 is a schematic partial side view of yet another alternative illustrative display and image-capture device, in accordance with aspects of the present disclosure.

FIG. 15 is a schematic partial top view of the device of FIG. 14.

FIG. 16 is a schematic partial top view of the device of FIG. 14, depicting electrical conductors connecting microcameras of the device to an electronic controller.

FIG. 17 is a schematic side view depicting illustrative lens surface profiles of the device of FIG. 14.

FIG. 18 is a schematic view depicting illustrative overlapping fields of view of microcameras of the device of FIG. 14, in accordance with aspects of the present teachings.

FIG. 19 is a schematic partial side view depicting yet another alternative illustrative display and image-capture device, in accordance with aspects of the present disclosure.

FIG. 20 is a schematic partial side view depicting yet another alternative illustrative display and image-capture device, in accordance with aspects of the present disclosure.

FIG. 21 is a schematic partial side view depicting yet another alternative illustrative display and image-capture device, in accordance with aspects of the present disclosure.

FIG. 22 is a schematic partial side view depicting yet another alternative illustrative display and image-capture device, in accordance with aspects of the present disclosure.

FIG. 23 is a schematic partial side view depicting an illustrative flexible display and image-capture device, in accordance with aspects of the present disclosure.

FIG. 24 is a schematic partial side view depicting another illustrative flexible display and image-capture device, in accordance with aspects of the present disclosure.

FIG. 25 is a schematic front view depicting an illustrative foldable display and image-capture device, in accordance with aspects of the present disclosure.

FIG. 26 is a schematic front view depicting an illustrative mobile phone having a display and image-capture panel, in accordance with aspects of the present disclosure.

FIG. 27 is a schematic partial front view depicting an illustrative substrate of the mobile phone of FIG. 26.

FIG. 28 is a schematic partial side view depicting an illustrative display and image-capture device having thin-film circuitry layers, in accordance with aspects of the present disclosure.

FIG. 29 is a schematic partial side view depicting another illustrative display and image-capture device having thin-film circuitry layers, in accordance with aspects of the present disclosure.

FIG. 30 is a schematic partial side view depicting an illustrative display and image-capture device having a thin-film circuitry layer, in accordance with aspects of the present disclosure.

FIG. 31 is a schematic partial side view depicting another illustrative display and image-capture device having a thin-film circuitry layer, in accordance with aspects of the present disclosure.

FIG. 32 is a schematic partial side view depicting yet another illustrative display and image-capture device having thin-film circuitry layers, in accordance with aspects of the present disclosure.

FIG. 33 is a schematic diagram depicting an illustrative integrated die having image-processing components and active matrix display circuitry components, in accordance with aspects of the present disclosure.

FIG. 34 is a schematic partial front view of an illustrative substrate including a plurality of integrated dies, in accordance with aspects of the present disclosure.

FIG. 35 is a schematic diagram of an illustrative electronic controller for a display and image-capture device, in accordance with aspects of the present disclosure.

FIG. 36 is a flow diagram depicting steps of an illustrative method for determining calibration parameters of a display and image-capture device, in accordance with aspects of the present disclosure.

FIG. 37 is a schematic side view of an illustrative display and image-capture device capturing images of reference objects in accordance with the method of FIG. 36.

FIG. 38 is a flow diagram depicting steps of an illustrative method for capturing image frames using a display and image-capture device, in accordance with aspects of the present disclosure.

FIG. 39 is a flow diagram depicting steps of an illustrative method for touch-sensing using a display and image-capture device, in accordance with aspects of the present disclosure.

FIG. 40 is a flow diagram depicting steps of an illustrative method for fingerprint sensing, in accordance with aspects of the present disclosure.

FIG. 41 is a schematic diagram of an illustrative display and image-capture device being used for videoconferencing, in accordance with aspects of the present disclosure.

FIG. 42 is another schematic diagram of the display and image-capture device of FIG. 41.

FIG. 43 is yet another schematic diagram of the display and image-capture device of FIG. 41.

FIG. 44 is a flow diagram depicting steps of an illustrative method for videoconferencing, in accordance with aspects of the present teachings.

### DETAILED DESCRIPTION

Various aspects and examples of a device having display and image capture functionality are described below and illustrated in the associated drawings. Unless otherwise specified, a display and image capture device in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion. The Examples, Components, and Alternatives section is further divided into subsections A through Q, each of which is labeled accordingly.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a display and image-capture device (AKA a panel) in accordance with the present teachings may include a substrate, a plurality of light-emitting devices disposed on the substrate, and a plurality of image-sensor devices disposed on the substrate. The image sensor devices each include a plurality of pixels.

In general, an image-sensor device may comprise a semiconductor die disposed on and/or in the substrate (e.g., a silicon die), thin-film circuitry (e.g. thin-film photosensors, transistors, diodes, resistors, and/or capacitors) fabricated on and/or in the substrate, a combination of thin-film circuitry and semiconductor die(s), and/or any other suitable device(s). In the illustrative examples described in the following sections, unless otherwise specified, image-sensing devices described as comprising dies may alternatively or additionally comprise thin-film circuitry.

Each light-emitting device may include a die, thin-film circuitry, and/or other suitable device having a light-emitting region configured to emit light in response to an electrical signal, and each image-sensor device may include a photosensor region configured to produce electrical signals (e.g., image data) in response to incident light. The light-emitting devices and image-sensor devices may each be distributed on the substrate to provide integrated display and image-capture functions. In some cases, a plurality of lenses may be disposed on a light-incident side of the image-sensor devices to direct light toward predetermined photosensor regions, or predetermined portions of photosensor regions. Together, a photosensor region and a lens configured to direct impinging light toward the photosensor region may be referred to as a microcamera.

In some of the drawings accompanying this description, illustrative display and image-capture devices are depicted in a schematic manner, in which the illustration includes only a few microcameras and/or light-emitting regions. In general, however, a display and image-capture device in accordance with aspects of the present teachings has tens, hundreds, thousands, millions, or more of microcameras and light-emitting display pixels.

A plurality of electrical conductors may be disposed on the substrate to connect the light-emitting devices and the image-sensor devices to an electronic controller and/or to a power source. Via the electrical conductors, the electronic controller may transmit display signals to the light-emitting devices and receive image data from the image-sensor dies. In some examples, the image data is processed by processing circuits associated with the image-sensor devices prior to being transmitted to the electronic controller.

In some examples, the electronic controller may transmit display signals directly to the light-emitting devices, and in other examples, the electronic controller may transmit display signals to one or more transistors, which switch and/or regulate current flow to the light-emitting devices. Such transistors are typically thin film transistors, and may be formed from the same material (e.g., gallium nitride, or GaN) as the light emitting devices. The transistors may also be included within an image sensor die. A system that uses transistors in this manner, i.e., to switch and/or regulate current flow between the electronic controller and the light emitting dies, may be described as an “active matrix” system. Phrases such as “transmit display signals to the light emitting dies” as used herein are intended to cover both direct transmission of display signals to the light-emitting dies (or other suitable light-emitting devices), and indirect transmission through transistors, in an active matrix manner.

The electronic controller may also transmit to the image-sensor devices, and/or to the associated processing circuits, command signals configured to determine a mode of operation of the image-sensor devices. The command signals may be configured to adjust one or more image-capture characteristics of the image-sensor devices, and/or of the entire device, by selectively processing and/or discarding image data corresponding to selected portions of the photosensor regions. Characteristics that may be adjustable by selectively processing data from portions of the photosensor regions may include field of view, depth of field, effective aperture size, focal distance, and/or any other suitable characteristic.

Additionally, or alternatively, the command signals may include a mode signal configured to switch the image-sensor devices between a two-dimensional (AKA “conventional”) image-sensing mode and a three-dimensional (AKA “plenoptic”, “light-field”, or “depth-sensing”) image-sensing mode. The plenoptic functionality may be enabled by reading image data from substantially the entirety of each photosensor region simultaneously, or nearly simultaneously. This data, in conjunction with a model of any lenses and/or other optical elements on a light-incident side of the image-sensor devices, may be used to obtain a directional distribution of the incident light, and thus enables light-field effects such as refocusing, noise reduction, and/or the like.

### Examples, Components, and Alternatives

The following sections describe selected aspects of exemplary display and image-capture devices, as well as related systems and/or methods. The examples in these sections are intended for illustration and should not be interpreted as limiting the entire scope of the present disclosure. Each section may include one or more distinct embodiments or examples, and/or contextual or related information, function, and/or structure.

### A. Illustrative Display and Image-Capture Device

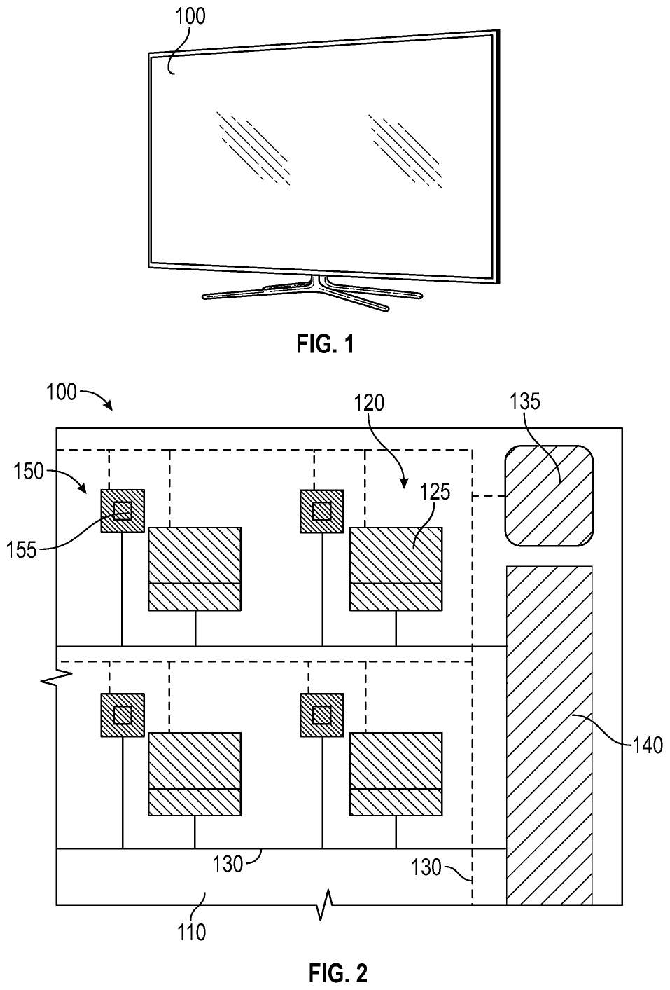

This section describes an illustrative device 100, shown in FIGS. 1-11. Device 100 is an example of a display and image-capture device in accordance with the present teachings, as described above.

FIG. 1 depicts illustrative device 100. Device 100 may comprise, or be integrated into, a monitor, television, computer, mobile device, tablet, interactive display, and/or any other suitable device. Device 100 may be configured to be rigid, flexible, and/or foldable, depending on the specific implementation. In the example depicted in FIG. 1, device 100 is planar (e.g., comprises a flat-panel device), but device 100 may alternatively, or additionally, comprise one or more curved and/or folded portions.

FIG. 2 is a partial top view depicting a portion of device 100. Device 100 includes a substrate 110 generally defining a plane. Substrate 110 can comprise glass, plastic, metal, and/or any other suitable materials. Substrate 110 may be monolithic, or may comprise a plurality of discrete substrate portions joined together.

A plurality of image-sensor devices 120 are disposed on substrate 110. In this example, devices 120 comprise image-sensor dies, but in other examples, the devices may comprise thin-film circuitry and/or any other suitable device(s). Each image-sensor die 120 includes a photosensor region 125 configured to produce an electrical signal in response to impinging light. For example, the electrical signal may comprise a digital and/or analog value (e.g., a voltage level) that depends on the intensity of the impinging light. The electrical signal comprises data representing a scene imaged by device 100 and accordingly may be referred to as image data. Image-sensor die 120 may further comprise a casing structure configured to support and/or protect photosensor region 125, to facilitate electrical connections to the photosensor region, and/or to dissipate heat.

Photosensor region 125 may comprise a CMOS sensor, CCD sensor, photodiode, and/or the like. In some examples, photosensor regions 125 are each configured to sense light within a same wavelength range. For example, each photosensor region 125 may be configured to sense light across the full visible spectrum, across a near-ultraviolet to near-infrared spectrum, and/or any other suitable spectrum. A photosensor region configured to sense at least a portion of the visible spectrum may include a color filter array having a pattern of filter portions configured to transmit red, blue, and green light respectively (e.g., a Bayer filter array). The filter array is disposed in front of a CMOS or other suitable sensor. The signal acquired by the sensor can be processed using demosaicing algorithm(s) and/or any other suitable methods.

In other examples, the plurality of photosensor regions 125 are not all configured to sense light within the same wavelength range. For example, each photosensor region 125 may be configured to sense a subset of the visible spectrum (e.g., a single color). In this case, device 100 may comprise photosensor regions 125 configured to sense red light, photosensor regions configured to sense green light, and photosensor regions configured to sense blue light. The single-color photosensor regions can be distributed on the device in any suitable pattern (e.g., in a pattern similar to a Bayer filter, and/or any other suitable layout), such that the device as a whole acquires full-color images. Single-color photosensor regions may allow a simpler optical design than full-color photosensor regions. For example, any lenses or other optical components associated with single-color photosensor regions would not generally need to be achromatic. Single-color photosensor regions may also allow for simpler processing (e.g., resolution enhancement, image enhancement, etc.). However, at least some aspects of manufacturing the device may be more complicated if the device includes non-identical photosensing regions rather than identical photosensing regions.

Electrical conductors 130 disposed on substrate 110 are configured to route power from a power source 135 to image-sensor dies 120, and to transmit image data from image-sensor dies 120 to an electronic controller 140. Electrical conductors 130 may include any suitable electrically conductive material, and may comprise wires, cables, ribbons, traces, and/or any other suitable structure. Electrical conductors 130 may be disposed on a surface of substrate 110, and/or may be embedded within the substrate. In some examples, the conductors may be optical rather than electrical.

Power source 135 may comprise any suitable device configured to provide electrical power via electrical conductors 130. In some examples, power source 135 comprises a power supply unit configured to receive mains power (e.g., from an electrical grid of a building) and, if necessary, to convert the received power into a form usable by device 100. Alternatively, or additionally, power source 135 may comprise one or more batteries and/or other suitable power storage devices.

Substrate 110 further includes a plurality of light-emitting dies 150. Each light-emitting die 150 has a respective light-emitting region 155, and may additionally include a casing structure as described above with reference to image-sensor dies 120. Light-emitting dies 150 are configured to produce light in response to an electrical display signal provided by electronic controller 140. For example, light-emitting dies 150 may each include one or more microLEDs (AKA mLEDS or pLEDs), OLEDs, and/or the like. Light-emitting dies 150 may further include color-conversion devices configured to convert the color of the light emitted by, e.g., a microLED, to a desired color. In some examples, each light-emitting die 150 includes three light-emitting regions 155 configured to output red, green, and blue light respectively (i.e., RGB sub-pixels). Electrical conductors 130 transmit to light-emitting dies 150 a display signal from electronic controller 140 and power from power source 135.

Light-emitting regions 155 comprise display pixels of the display system of device 100, and photosensor regions 125 comprise input pixels of the image-capture system of device 100. Accordingly, light-emitting dies 150 and image-sensor dies 120 are arranged on substrate 110 in a manner configured for displaying and capturing images with suitable pixel resolution. For example, light-emitting dies 150 and image-sensor dies 120 may be distributed in a regular pattern across the entirety, or the majority, of substrate 110. In some examples, portions of substrate 110 include light-emitting dies 150 but no image-sensor dies 120, or vice versa. For example, image-sensor dies 120 may be included in central portions of substrate 110 but omitted from edge portions of the substrate.

In the example shown in FIG. 2, light-emitting dies 150 and image-sensor dies 120 are collocated on substrate 110, with a light-emitting die positioned near each image-sensor die. That is, light-emitting dies 150 and image-sensor dies 120 are distributed on substrate 110 in a one-to-one ratio. In other examples, however, device 100 includes more light-emitting dies 150 than image-sensor dies 120, or vice versa. The ratio may be selected based on, e.g., the display pixel resolution and/or image-capture pixel resolution required for a specific implementation of device 100, on a desired processing speed and/or capacity of device 100, on the number of electrical conductors 130 that can fit on substrate 110, and/or on any other suitable factors.

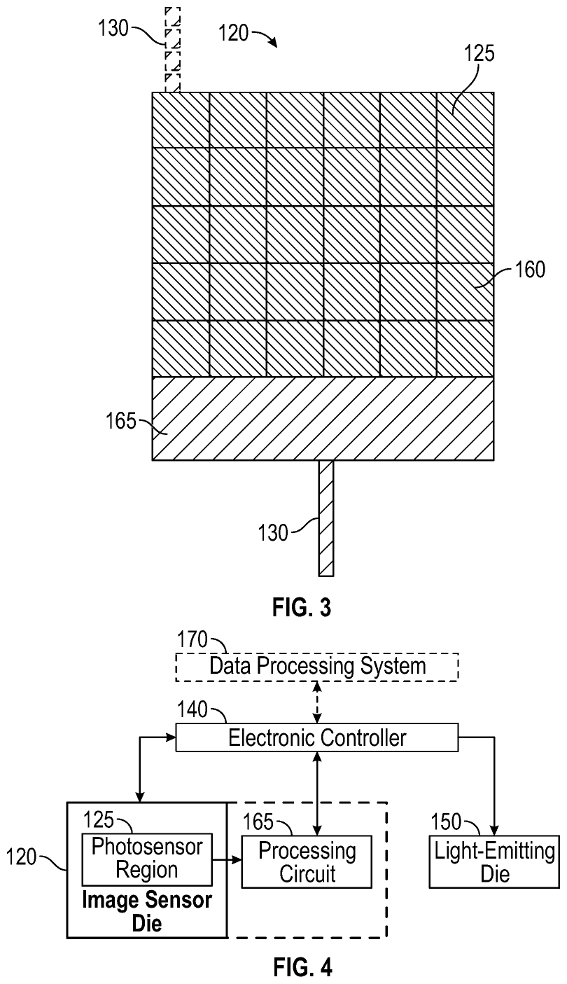

FIG. 3 schematically depicts an illustrative image-sensor die 120 in more detail. In this example, photosensor region 125 of image-sensor die 120 includes a plurality of image-sensing pixels 160 arranged in a two-dimensional array. For example, photosensor region 125 may comprise a CCD array and/or a CMOS array.

Illustrative image-sensor die 120 further includes a processing circuit 165 configured to receive and process image data from photosensor region 125, and to transmit the processed image data to electronic controller 140. Processing the image data may include discarding a portion of the image data, compressing the data, converting the data to a new format, and/or performing image-processing operations on the data. Image-processing operations may include noise reduction, color processing, image sharpening, and/or the like.

Processing circuit 165, which may also be referred to as processing logic, may include any suitable device or hardware configured to process data by performing one or more logical and/or arithmetic operations (e.g., executing coded instructions). For example, processing circuit 165 may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

In the example shown in FIG. 3, processing circuit 165 is included in image-sensor die 120. In other examples, however, processing circuit 165 may be disposed on substrate 110 separately from image-sensor die 120. Additionally, or alternatively, each processing circuit may receive and process data from several image-sensor dies.

FIG. 4 schematically depicts data flow within device 100. Electronic controller 140 is configured to transmit display signals to light-emitting die 150. The display signals are configured to cause light-emitting region 155 to emit light with a selected intensity and, if appropriate, color.

Electronic controller 140 is further configured to transmit mode signals and/or other commands to image-sensor die 120, and to receive image data from the image-sensor die. In examples including processing circuit 165, electronic controller 140 may transmit mode signals to the processing circuit, which may receive image data from photosensor region 125, process the data in accordance with a mode specified by the mode signal, and transmit the processed data to the electronic controller. However, electronic controller 140 may additionally or alternatively be configured to transmit command signals to and/or receive data from a portion of the image sensor die that is not processing circuit 165.

In some examples, electronic controller 140 is connected to at least one data processing system 170, also referred to as a computer, computer system, or computing system. Data processing system 170 typically runs one or more applications related to device 100, such as a videoconferencing application, game, virtual reality and/or augmented reality application, and/or any other application configured to use the display and/or image capture functions of device 100. Data processing system 170 may provide instructions to electronic controller 140 to transmit display signals to light-emitting dies 150 corresponding to a desired image (e.g., a video frame received by a videoconferencing application). Additionally, or alternatively, data processing system 170 may provide instructions related to the image-capture function of device 100. Data processing system 170 may include an interface configured to allow users to adjust settings related to display and/or image-capture functions of device 100.

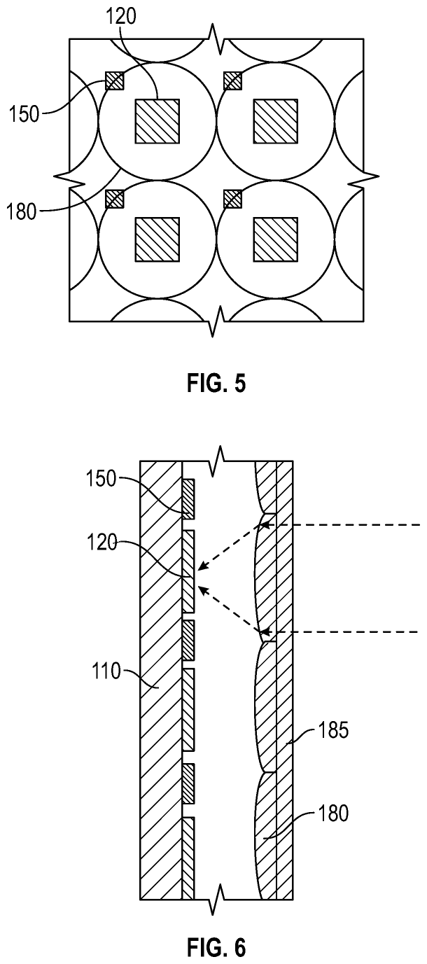

As shown in FIGS. 5-6, device 100 may further include a plurality of lenses 180 disposed on a light-incident side of image-sensor dies 120. In the example shown in FIGS. 5-6, a respective one of lenses 180 is disposed on a light-incident side of each image-sensor die 120, and each lens is configured to focus light on or toward photosensor region 125 of the corresponding image-sensor die. In other examples, each lens 180 may be configured to focus light on any one of several image-sensor dies 120 based on an angle of incidence of the light. (See, for example, FIG. 12 and associated description.) Typically, in these examples, lenses 180 and image-sensor dies 120 are arranged such that each image-sensor die receives light from only one lens.

Lenses 180 may comprise convex lenses, plano-convex lenses, achromatic lenses (e.g., achromatic doublets or triplets), aspheric lenses, circular lenses, truncated circular lenses, and/or any other suitable type of lens. In some examples, lenses 180 comprise a plurality of microlenses disposed on a microlens substrate (e.g., a microlens array). In some examples, lenses 180 comprise metalenses,

A protective layer 185 may be disposed on a light-incident side of lenses 180 to protect the lenses and other components of device 100. Protective layer 185 is typically substantially optically transparent and may include one or more coatings or other components configured to be scratch-resistant, water-resistant, anti-reflective, anti-glare, anti-friction, and/or to have any other suitable properties.

In some examples, an air gap extends between lenses 180 and image-sensor dies 120. Alternatively, the gap, or portions thereof, may be at least partially filled with a material having suitable optical properties. For example, the gap may include material having a refractive index substantially equal to a refractive index of lenses 180, and/or a refractive index of a microlens substrate supporting lenses 180. Optical properties of any material positioned within the gap may be configured to facilitate outcoupling of light emitted by light-emitting dies 150, i.e., to increase the amount of emitted light emitted toward a viewer.

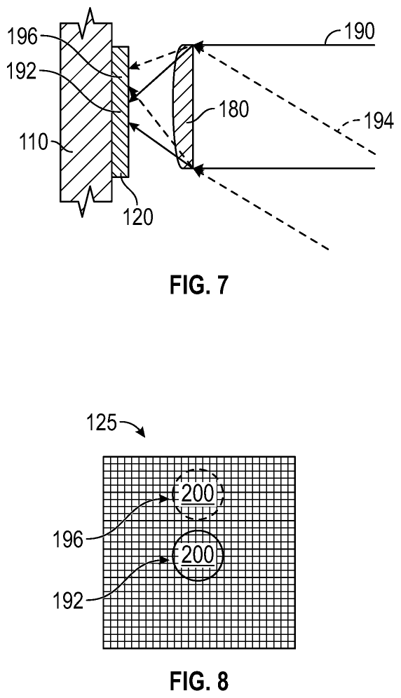

Depending on the properties of lens 180 and the size of photosensor region 125, the spot size of light focused by the lens toward the photosensor region may be smaller than the photosensor region. In this case, only a portion of photosensor region 125 is impinged upon by the light. The impinged-upon portion is typically determined by a direction of the incident light, e.g., an angle of incidence between the light and lens 180. FIG. 7 depicts a first portion of light, indicated at 190, impinging upon lens 180 at a 90° angle (e.g., a 0° angle of incidence relative to an axis normal to the surface of the lens). First portion of light 190 is focused onto a first photosensor portion 192. Second portion of light 194 impinges on lens 180 from a different direction and is therefore focused onto a second photosensor portion 196.

As shown in FIG. 8, in examples in which photosensor region 125 includes an array of image-sensing pixels 160, the photosensor portion impinged upon by light passing through lens 180 comprises a subset of the image-sensing pixels. The relationship between the position of an image-sensing pixel 160 on photosensor region 125 and the incident angle between lens 180 and the impinging light detectable by the pixel is determined at least partially by optical properties of the lens, such as focal length, f-number, diameter, curvature, and/or the like. Due to this relationship, directional information (e.g., radiance) about detected light can be inferred based on which pixels 160 detected the light. Accordingly, device 100 is capable of functioning as a plenoptic camera. For example, processing circuit 165 may be configured to process and transmit image data measured by a selected subset 200 of image-sensing pixels 160. Subset 200 may correspond to, e.g., a desired direction and/or acceptance angle of light to be measured. FIG. 8 shows the subsets 200 of pixels 160 that measure data associated with first portion of light 190 (at first photosensor portion 192) and second portion of light 194 (at second photosensor portion 196).

The position and/or extent of subset 200 may at least partially determine the field of view, effective aperture, focal distance, and/or depth of field of the optical system formed by photosensor region 125 and the corresponding lens 180. For example, the effective aperture size and field of view may be increased by increasing the number of pixels 160 in subset 200.

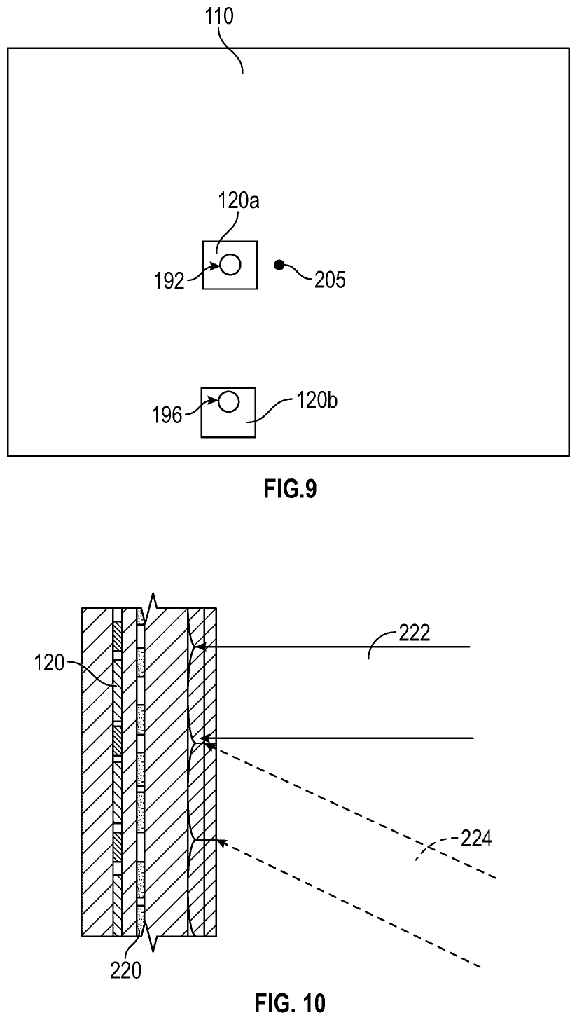

The selection of subset 200 for each image-sensor die 120 may depend on a location of the image-sensor die on substrate 110. In other words, the position and extent of subset 200 on photosensor region 125 may be selected based on the position of the associated image-sensor die 120. FIG. 9 schematically depicts illustrative image-sensor dies 120a and 120b disposed at different locations on substrate 110. Die 120a is positioned near a central point 205 of substrate 110, and die 120b is positioned near an edge of the substrate, far from the central point. Subset 200 of die 120a is positioned at a central portion of photosensor region 125, corresponding to photosensor portion 192 shown in FIGS. 7-8. Subset 200 of die 120b is positioned at an edge portion of photosensor region 125, corresponding to photosensor portion 196 shown in FIGS. 7-8. Specifically, die 120b is positioned near a bottom edge of substrate 110, and the corresponding subset 200 is positioned near a top edge of associated photosensor region 125. This configuration extends the field of view of device 100 beyond the bottom edge of substrate 110, enabling the device to receive light from objects that would otherwise lie outside the field of view. In some examples, processing circuits 165 corresponding to all image-sensor dies 120 disposed near edges of substrate 110 are configured to read data from subset 200 positioned such that the field of view of device 100 is increased by a predetermined amount.

Alternatively, or additionally, processing circuit 165 may be configured to receive and process data from substantially the entirety of photosensor region 125 and to send the entire set of processed data to electronic controller 140. Electronic controller 140 and/or associated data processing system 170 may be configured to process selected subsets of the image data corresponding to data originally recorded by selected pixel subsets. In this way, the focal distance, depth of view, effective aperture size, field of view, and/or any other suitable property of an image captured by device 100 can be adjusted after the image data has been received. Image processing may be performed on the set of data corresponding to substantially the entirety of photosensor region 125 of some or all image-sensor dies 120.

FIG. 10 depicts an illustrative field-stop layer 220 disposed between lenses 180 and image-sensor dies 120. Field-stop layer 220, according to aspects of the present teachings, includes a patterned mask configured to prevent light focused by each lens from reaching any photosensor region 125 other than the photosensor region associated with the lens. In examples in which each lens 180 is associated with exactly one photosensor region 125, field stop layer 220 is configured to prevent each photosensor region from receiving light from more than one lens 180. FIG. 10 depicts an illustrative accepted light portion 222 that passes through an opening in field-stop layer 220 and is focused onto image-sensor die 120, as well as a blocked light portion 224 that is prevented by field-stop layer 220 from reaching the same image-sensor die. Field-stop layer 220 helps to facilitate the measurement of directional information by device 100 by preventing light from several different directions from impinging on a same pixel subset 200.

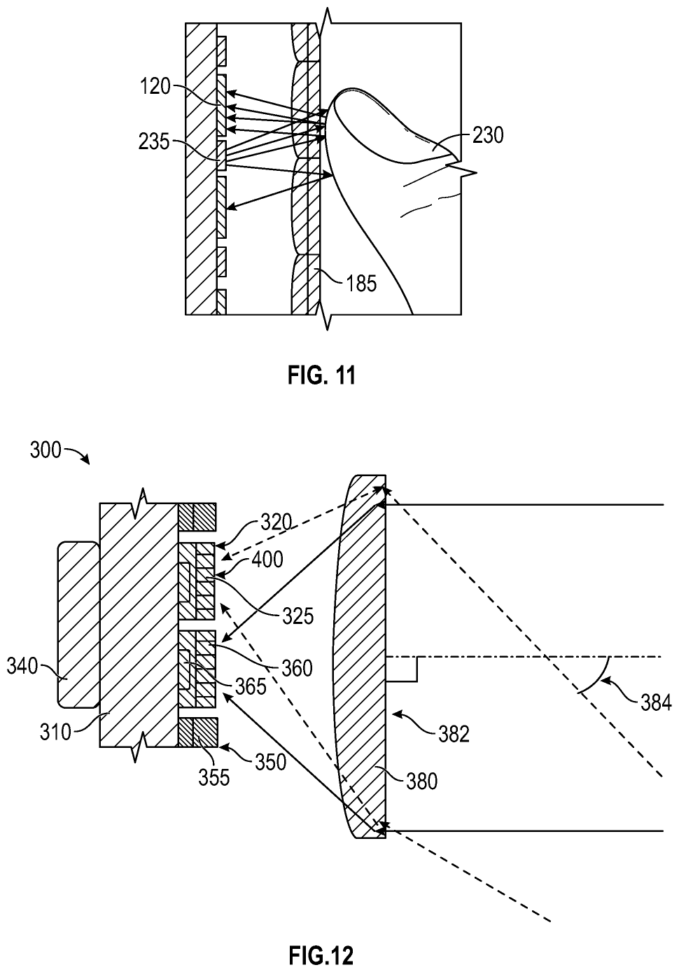

FIG. 11 depicts an illustrative example in which device 100 is configured to be touch-sensitive, e.g., to detect a touch object 230. Touch object 230 may comprise a user's hand, a stylus, and/or any other suitable object contacting or nearly contacting a front surface of the device, such as protective layer 185. In this example, image-sensor dies 120 are configured to detect light reflected from touch object 230 and to transmit the data to electronic controller 140. Electronic controller 140 and/or data processing system 170 is configured to determine information about touch object 230 based on the received data. Determining information about touch object 230 may include, e.g., calculating a centroid of the reflected light, and/or analyzing a shape of the area from which the light is reflected. Based on the determined information, device 100 recognizes that touch object 230 is contacting (or hovering over) the device, and responds accordingly. For example, an application running on data processing system 170 may display interactive objects on device 100 using light-emitting dies 150, and a user may interact with the objects using touch object 230. Additionally, or alternatively, display and/or image-capture settings of device 100 may be adjustable using touch object 230.

In some examples, the light reflected from touch object 230 and received by image-sensor dies 120 is light originally emitted by light-emitting dies 150 for display purposes. Alternatively, or additionally, secondary light-emitting dies 235 may be disposed on substrate 110 and configured to emit light to be reflected from touch object 230. Secondary light-emitting dies 235 typically emit light that is configured to be readily distinguishable from light emitted by light-emitting dies 150. In some examples, secondary light-emitting dies 235 emit light having a longer wavelength than the light emitted by light-emitting dies 150. For example, light-emitting dies 150 may emit light that lies predominantly within the visible spectrum, and secondary light-emitting dies 235 may emit infrared light. The reflected infrared light may be detected with a better signal-to-noise ratio than light emitted by light-emitting dies 150. In some examples, secondary light-emitting dies 235 may be powered off or otherwise disabled when not in use.

Electronic controller 140 may be configured to determine a mode of operation of device 100 by sending suitable electrical signals to at least some light-emitting dies 150, image-sensing dies 120, secondary light-emitting dies 235, processing circuits 165, and/or any other suitable device components. For example, electronic controller 140 may switch device 100 into a touch-sensitive mode of operation by sending to secondary light-emitting dies 235 a signal configured to activate the secondary light-emitting dies. Additionally, or alternatively, electronic controller 140 may switch device 100 into a plenoptic-camera mode by sending to processing circuits 165 a signal configured to cause the processing circuits to receive, process, and transmit data from a large portion of the associated photosensor regions 125 (e.g., a portion corresponding to light impinging on associated lens 180 from a large range of directions). Additionally, or alternatively, electronic controller 140 may switch device 100 into a two-dimensional or conventional camera mode by sending to processing circuits 165 a signal configured to cause the processing circuits to receive, process, and transmit data from only a selected subset 200 of associated photosensor regions 125. In the conventional camera mode, directional information is typically not included in the image data, but the volume of data processed and transmitted may be smaller, which may allow for faster device operations (e.g., a faster video frame rate).

In some examples, the field of view of device 100 is at least partially determined by the relative position between each lens 180 and the image-sensor die or dies 120 onto which each lens focuses light. For example, lenses 180 disposed near middle portions of substrate 110 may be centered above the corresponding image-sensor dies 120, and lenses near edge portions of the substrate may be positioned away from the centers of the corresponding image-sensor dies (e.g., they may be decentered). Additionally, or alternatively, lenses 180 may have a different shape (e.g., a different surface profile) based on their distance from central point 205 of substrate 110. This allows lenses near edge portions of the substrate to accept light impinging from directions relatively far from a normal (i.e., directions defining relatively large angles with respect to an axis normal to the substrate), which may extend the field of view of device 100 and/or improve the imaging resolution of the device by preventing field-curvature effects that might otherwise occur at edges of the device's field of view.

Alternatively, each microcamera of the device may have a wide field of view. A wide field of view may be achieved by, e.g., a microcamera having a lens smaller in diameter than the associated image sensor, or by any other suitable configuration. The wide fields of view of microcameras at the periphery of the device allows the device as a whole to have a wide field of view. Because all of the microcameras have wide fields of view, there is significant overlap between the fields of view of nearby microcameras. This can allow for use of image processing techniques such as super resolution and/or deconvolution to achieve high resolution. Additionally, if the microcameras have identical lenses, manufacturing may be simplified.

Alternatively, each microcamera of the device may be configured (e.g., based on lens type, shape, and/or position relative to the associated image sensor) to sample a small field of view, such that there is relatively little overlap between the fields of view of nearby microcameras. In some cases, this is achieved by using a unique lens for each microcamera of the device. As described above, microcameras disposed at peripheral portions of the device may have fields of view accepting light impinging from a direction relatively far from an axis normal to the device substrate. This effectively extends the field of view of the device, and may reduce or prevent field-curvature effects.

In some examples, substrate 110 comprises a plurality of zones, and image-sensor dies 120 and lenses 180 within a same zone are configured to have a same field of view and/or a same effective aperture. For example, the device may include clusters of microcameras, with microcameras within a cluster having identical lenses. Each cluster can be configured to sample a different field of view, which can be relatively narrow (e.g., compared to equally many microcameras configured to have wide fields of view). The angular range sampled by the cluster may depend on the position of the cluster on the device, as described above. There can be significant overlap in sampled field between microcameras in a same cluster, facilitating resolution-enhancement techniques. A high-resolution image can be obtained by merging resolution-enhanced images acquired by a plurality of clusters. In some cases, image data acquired by a plurality of clusters can be processed in parallel (e.g., in a partitioned manner), allowing for faster and/or more efficient processing. A cluster of microcameras may have any suitable number and arrangement of microcameras (e.g., several microcameras per cluster, tens of microcameras per cluster, or more). As one example, a large format display and image-capture device (e.g., having a 65 inch diagonal) may include clusters of 45 microcameras arranged in 9×5 arrays. However, a device having microcamera clusters may have any suitable cluster arrangement.

In some examples, image-sensor dies 120 are distributed across only a portion of substrate 110, so that only a portion of device 100 has image-capture functionality. Additionally, or alternatively, light-emitting dies 150 may be distributed across only a portion of substrate 110, so that only a portion of device 100 has display functionality. Limiting image-sensor dies 120 and/or light-emitting dies 150 to a portion of substrate 110 may lower the manufacture cost and/or power consumption of the device.

### B. Second Illustrative Example

This section describes another illustrative device 300 configured for display and image capture according to the present teachings. Device 300 is substantially similar in some respects to device 100, described above. Accordingly, as shown in FIG. 12, device 300 includes a substrate 310 and a plurality of image-sensor dies 320 disposed on the substrate, each image-sensor die having a photosensor region 325. As described above, in some examples photosensor regions 325 comprise thin-film circuitry fabricated on or in substrate 310, rather than image-sensor dies.

Device 300 further includes an electronic controller 340 and a plurality of light-emitting dies 350 disposed on the substrate, each light-emitting die having a light-emitting region 355. Electronic controller 340 is configured to transmit mode information to image-sensor dies 320, to receive image data from the image-sensor dies, and to transmit display signals to light-emitting dies 350. Each photosensor region 325 may comprise a two-dimensional array of pixels 360, depicted in side view in FIG. 12. Processing circuits 365 may be disposed on the substrate, and/or included in image-sensor dies 320. Processing circuits 365 are configured to receive image data from pixels 360, to process the image data, and to transmit the processed image data to electronic controller 340.

Device 300 further includes a plurality of lenses 380 disposed on a light-incident side of image-sensor dies 320. Lenses 380 are each configured to direct light impinging on a front surface 382 of the lens toward a predetermined one of photosensor regions 325 based on an angle of incidence 384 between the impinging light and the front surface of the lens. In contrast, lenses 180 of device 100 are each configured to focus incident light on one of photosensor regions 125, and the incident light may be directed toward a predetermined portion of the photosensor region based on the angle of incidence between the light and the lens. Accordingly, device 100 is configured to obtain directional information about incident light based on which portion of photosensor region 125 detects the light, and device 300 is configured to obtain directional information about incident light based on which photosensor region 325 detects the light. However, device 300 may obtain additional directional information based on which portion of photosensor region 325 detects the light.

As described above with reference to device 100, processing circuits 365 of device 300 may be configured to selectively process and transmit image data corresponding to only a subset 400 of pixels 360. Processing and transmitting image data from only subset 400 may, for example, effectively determine an effective aperture size and/or field of view for the imaging system comprising lens 380 and the associated image-sensor dies 320.

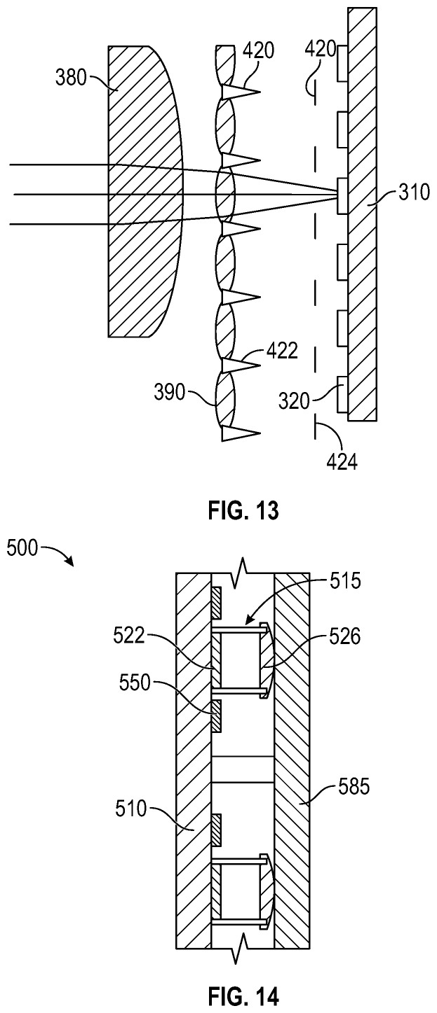

Device 300 may further include a plurality of microlenses 390, as shown in FIG. 13. Microlenses 390 are disposed on a light-incident side of each image-sensor die 320 (e.g., between the image-sensor die and lens 380) and are configured to focus incident light on photosensor region 325 of the image-sensor die. Microlenses 390 may comprise a microlens array layer.

A field-stop layer 420 may be disposed between microlenses 390 and image-sensor dies 320 to inhibit light focused by each microlens from reaching more than one of the photosensor regions 325. In the example depicted in FIG. 13, field-stop layer 420 includes field-stop barriers 422 disposed between adjacent microlenses 390 and extending toward substrate 310, and further includes a mask layer 424 disposed between the field-stop barriers and the substrate. In some examples, microlenses 390 comprise a microlens array formed on an array substrate, and field-stop barriers 422 are part of the array substrate.

### C. Illustrative Microcamera Device

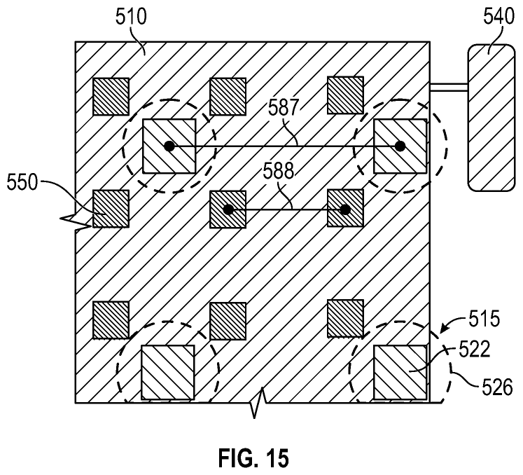

This section describes yet another illustrative device 500 configured for display and image capture according to the present teachings. In some respects, device 500 is substantially similar to device 100 and to device 300. Accordingly, as shown in FIGS. 14-15, device 500 includes a substrate 510. A plurality of microcameras 515 are disposed on substrate 510. Each microcamera 515 includes an image sensor 522 and a microcamera lens 526 configured to direct incident light onto the image sensor. In some examples, microcamera lens 526 is attached to image sensor 522 (e.g., to a die and/or other suitable support structure of the image sensor). For example, microcamera lens 526 and image sensor 522 may be packaged together as a microcamera chip. Microcameras 515 may comprise full-color cameras configured to sense all or nearly all wavelengths of visible spectrum, and/or single-color microcameras configured to sense light within a portion of the visible spectrum (e.g., a single color). In examples wherein microcameras 515 comprise single-color cameras, microcameras having different color-sensing capabilities may be distributed across device 500 such that the device captures full-color images.

Device 500 further includes at least one electronic controller 540 and a plurality of light-emitting elements 550 disposed on the substrate. Electronic controller 540 is configured to receive image data related to light incident on image sensor 522 of microcamera 515, and to transmit display signals to light-emitting elements 550. Electronic controller 540 may be further configured to transmit to microcameras 515 signals configured to switch an image-sensing mode of the microcameras, as described above with reference to device 100. Device 500 may further include one or more processing circuits configured to receive and process image data from a subset of microcameras 515, and to transmit the processed data to electronic controller 540.

At least one protective layer 585 may be disposed on a light-incident side of the plurality of microcameras 515 to protect the microcameras, light-emitting elements 550, and other components. Protective layer 585 is typically a substantially optically transparent protective layer overlying microcameras 515 and light-emitting elements 550. Protective layer 585 may be configured to protect underlying components from dust and other debris, from impact, from liquid and/or condensation, and/or the like.

Typically, each microcamera 515 is optically isolated from other microcameras. Accordingly, light incident on one of the lenses 526 can typically be directed onto only the corresponding image sensor 522 of the same microcamera 515, rather than onto the image sensor of a neighboring microcamera. For example, the imaging properties of lens 526 and the dimensions of microcamera 515 may be configured such that substantially no light incident on the lens can reach any other microcamera. This configuration may be enabled by manufacturing microcamera 515 as an integral chip. In contrast, this configuration may not be achievable in example devices that are fabricated by attaching image-sensor dies to a substrate and subsequently attaching lenses (e.g., a microlens array) to the device. Accordingly, a field-stop layer is typically unnecessary in device 500. However, it is possible to include a field-stop layer in device 500.

In the example shown in FIGS. 14-15, microcameras 515 are distributed more sparsely on substrate 510 than are light-emitting elements 550. Microcamera pitch 587 (e.g., a distance between the centers of adjacent microcameras) is greater than light-emitting element pitch 588. In some examples, light-emitting element pitch 588 is less than 1.3 millimeters. The width (e.g., diameter) of microcamera lenses 526 is typically small enough, relative to light-emitting element pitch 588, that light emitted by light-emitting elements 550 is not blocked by microcameras 515. For example, lenses 526 may have diameters in the range 30-1200 microns (e.g., 300 microns). In at least some cases, the microcamera has a width of 1.3 millimeters or less, and a pixel pitch of 1.3 millimeters or less. For example, a 100 inch diagonal, 1920×1080 resolution display, has a display pixel pitch of approximately 1200 microns, so the microcamera lens width may be approximately 1200 microns or smaller. For a smaller, high resolution display such as a mobile phone or watch, the display pixel pitch may be 50 microns and thus the microcamera lens width may be approximately 50 microns or smaller.

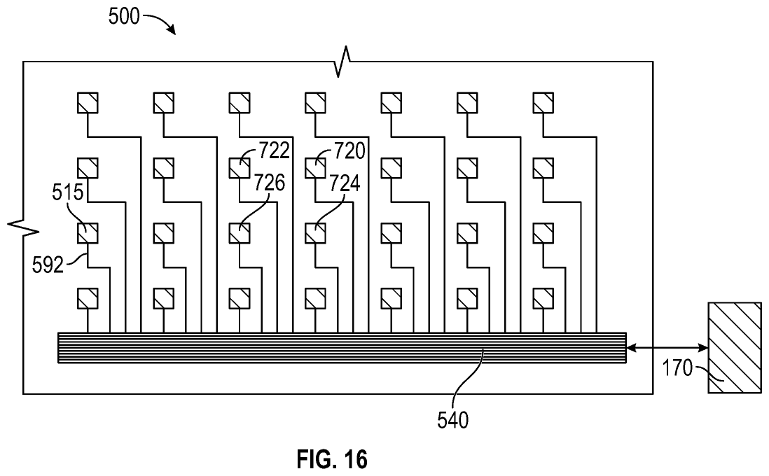

As shown in FIG. 16, one consequence of the relatively high microcamera pitch 587 is that that electrical conductors 592 can be configured to connect each microcamera 515 directly to electronic controller 540. The individual connection of microcameras 515 to electronic controller 540 may enable device 500 to operate with greater speed, and/or may increase control of the relative timing of operation of microcameras on different parts of substrate 510. In contrast, in examples in which microcamera pitch 587 is smaller, there may not be enough space on the substrate for the number of conductors necessary to directly connect individual image sensors to the controller.

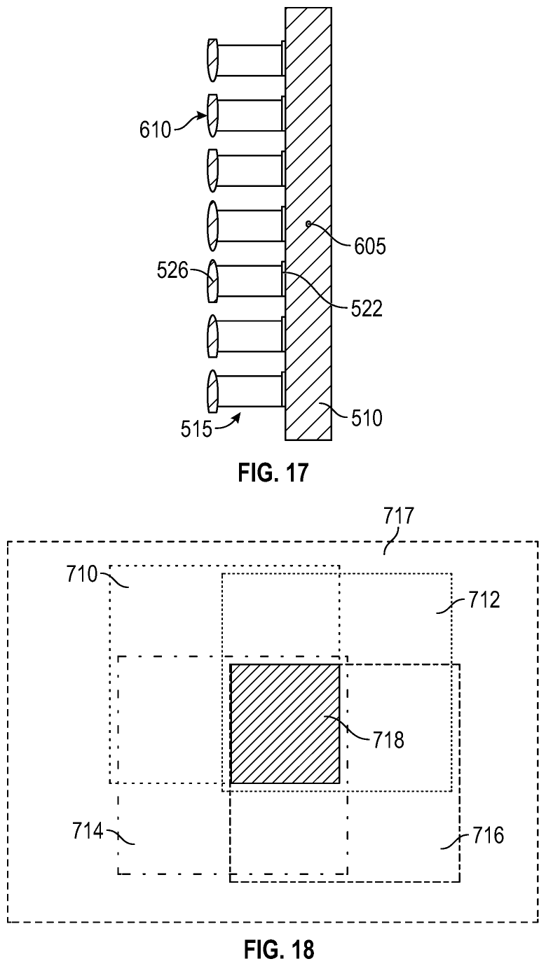

In some examples, lenses 526 have a different shape based on the position of the corresponding microcamera 515 on substrate 510. FIG. 17 is a schematic side view of device 500 depicting illustrative microcameras 515 disposed at a plurality of distances from a central point 605 of substrate 510. In this example, lenses 526 are aspheric lenses, and each lens has a surface profile 610 that depends on the distance of the lens from central point 605. Lenses 526 of microcameras 515 disposed far from central point 605 (e.g., near edges of substrate 510) may have respective surface profiles 610 configured to extend the field of view of device 500 beyond the edges of the substrate. For example, surface profiles 610 of lenses 526 disposed near a bottom edge of substrate 510 may be configured to direct light onto an upper region of the corresponding image sensors 522. In some examples, the optic axis of each lens 526 is tilted (e.g., relative to an axis normal to substrate 510) by an amount that depends on the distance from the lens to central point 605; the farther the lens is from the central point, the greater the tilt amount. In some examples, lenses 526 comprise metalenses. For example, lenses 526 may comprise achromatic metalenses configured to focus a broad range of wavelengths of light (e.g., the visible spectrum). Alternatively, or additionally, at least some lenses 526 may comprise monochromatic or quasi-monochromatic metalenses configured to focus light in a narrow range of wavelengths (e.g., a single color). A microcamera having a monochromatic or quasi-monochromatic metalens may include a color filter to further narrow the wavelength range of light sensed by the microcamera.

Device 500 may take the form of a display screen suitable for use in a conference room, classroom, and/or the like. For example, device 500 may comprise a monitor having a diagonal extent of 80 inches or greater (e.g., 86 inches).

### D. Illustrative Resolution Enhancement

Display and image-capture devices in accordance with the present teachings may be configured to capture image data suitable for enhancement using image-processing techniques. This section describes an illustrative resolution enhancement for increasing the resolution of images obtained by the device beyond a resolution obtainable without processing. Unless otherwise specified, the term “resolution” as used herein refers to the minimum far field spot size resolvable by a device or device component. Accordingly, the term “resolution enhancement” refers to a reduction in the minimum resolvable far field spot size. For clarity, the resolution enhancement process is described here with reference to illustrative device 500 having microcameras 515, but substantially similar resolution enhancement may be performed using any device in accordance with the present teachings.

Microcameras 515 may be configured to have overlapping fields of view. FIG. 18 schematically depicts projections of overlapping fields of view 710, 712, 714, and 716 onto an example object plane 717. Fields of view 710-716 all overlap each other in an overlap region 718 of object plane 717. These fields of view correspond to respective microcameras 720, 722, 724, and 726, labeled in FIG. 16. In general, all microcameras 515 are arranged on substrate 510 such that nearly all portions of the scene imageable by device 500 lie within a similar overlap region for a large range of object planes (e.g., for object planes at substantially any distance from the device).

Overlap region 718 is located in a portion of object plane 717 where fields of view 710-716 overlap, and therefore the overlap region is imaged by microcameras 720-726. That is, microcameras 720-726 all receive light from overlap region 718 and therefore all record image data corresponding to that portion of object plane 717. Because overlap region 718 is imaged by more than one microcamera, the overlap region may be said to be oversampled by device 500. Image-processing algorithms may be used to produce an image of the oversampled overlap region 718 of object plane 717 that has a higher resolution and signal-to-noise ratio than the image data obtained by any one of microcameras 720-726. Suitable image processing techniques may include super-resolution algorithms based on Bayesian estimation (e.g., Bayesian multi-channel image resolution), deep convolutional networks, and/or any other suitable algorithms. In some cases, the image-processing techniques include deconvolution techniques configured to improve image quality by reversing degradation, distortion, and/or artifacts induced by the measurement process; an example is discussed in the next section.

A resolution-enhanced image of each overlap region 718 on object plane 717 is produced by electronic controllers and/or processing circuits of the device. The resolution-enhanced images are typically stitched together at image edges to produce a resolution-enhanced image of the entire scene (e.g., the entire portion of the object plane lying within the field of view of the device). As shown in FIG. 18, regions of partial overlap may extend beyond overlap region 718, which may facilitate accurate alignment of the resolution-enhanced images when the resolution-enhanced images are stitched together.

Typically, when the device is operating in plenoptic mode, it simultaneously collects image data corresponding to a plurality of object planes. Accordingly, resolution-enhancement may be performed for images corresponding to a plurality of object planes. This may allow for techniques associated with the plenoptic function to be performed using resolution-enhanced data. Image processing for a plurality of overlap regions and/or object planes may be performed in parallel by processing circuits disposed on the substrate. Parallel processing techniques may be used to enable image processing for the entire object plane (or plurality of object planes) to be performed relatively quickly, so that the device can produce resolution-enhanced images at an acceptable frame rate.

Image-processing techniques based on oversampling, as described above, may effectively increase device sensitivity as well as device resolution. Oversampling increases device sensitivity because light from a single region (e.g., overlap region 718) is recorded by more than one microcamera. Accordingly, a signal-to-noise ratio associated with the device may be enhanced.

### E. Illustrative Data Flow

This section describes an illustrative system for sending data to and from image-sensor dies and light-emitting dies of a display and image-capture device, in accordance with aspects of the present teachings. For clarity, the data flow system is described below with reference to device 100; however, the data flow system may be applied to any suitable device.

As described above with reference to FIG. 2, electrical conductors 130 disposed on substrate 110 are configured to communicate data between electronic controller 140 and image-sensor dies 120, and between the electronic controller and light-emitting dies 150. Adequate performance of device 100 may depend on the timing of data communications within the device. For example, if video data is to be displayed using light-emitting dies 150 as video pixels, then the light-emitting dies typically must be configured to respond to display signals at substantially the same time. If video data is to be recorded using image-sensor dies 120, then the image-sensor dies typically must produce image data in a synchronized way. However, control over the timing of data communications within device 100 is typically subject to several constraints. For example, the speed at which data is able to travel from a first location on device 100 to a second location may be limited by the length of electrical conductor 130 that connects the two devices, and/or by the amount of data that may be transferred by the conductor in a given time interval. The amount of data being transferred, and therefore the time necessary for the data transfer, may depend on the extent of photosensor region 125 from which processing circuits 165 receive data. A data set corresponding to only a subset 200 of pixels 160, for example, is typically smaller than a data set corresponding to the entire pixel array. Accordingly, device 100 may have a lower video-capture frame rate when operating in a plenoptic camera mode than when operating in a conventional camera mode. The maximum achievable frame rates of video capture and video display, however, may be limited by the number of electrical conductors 130 that can fit on substrate 110. These timing considerations, among others, may at least partially determine the flow of data within device 100.

FIG. 2 depicts an example of device 100 in which image-sensor dies 120 and light-emitting dies 150 are disposed in rows and columns on substrate 110. In this example, electrical conductors 130 are configured to electrically connect the image-sensing dies 120 in each row to each other, and to electrically connect each row to electronic controller 140. Similarly, electrical conductors 130 are configured to electrically connect the light-emitting dies 150 in each row to each other, and to electrically connect each row to electronic controller 140. In other examples, electrical conductors 130 may additionally or alternatively connect image-sensing dies 120 (or light-emitting dies 150) in each column to each other, and to electrically connect each column to electronic controller 140. In yet other examples, individual image-sensing dies 120 and/or light-emitting dies 150 may each be directly connected to electronic controller 140; see FIG. 16 and associated description.

Electronic controller 140 may be configured to send a trigger signal to each row of image-sensor dies 120. The trigger signal may be configured to cause each image-sensor die 120 in the row to begin measuring incident light (e.g., to begin an exposure time, to open hardware and/or software shutters, and so on), either immediately or within a predetermined time interval. The interval may be based on the position of the die within the row, such that each die in the row begins measurement at substantially the same time. Electrical conductors 130 may be distributed on substrate 110 in any configuration suitable to facilitate this system. Electronic controller 140 may similarly be configured to send display signals to each row or column of light-emitting dies 150.

Processing circuits 165 may be configured to read and/or process data from image-sensor dies 120 in each row to produce a respective set of row data corresponding to each row, and to transmit the row data from each row to electronic controller 140. In this manner, image data recorded by image-sensor dies 120 within a given row arrive at electronic controller 140 at substantially the same time (e.g., within an acceptable tolerance).

As discussed in the previous section, image data resolution may be improved using resolution-enhancing image-processing techniques, such as deconvolution. In examples in which photosensor regions 125 each comprise a two-dimensional array of pixels 160, deconvolutions may be performed on the image data in the following manner. After image data has been recorded (e.g., after the end of an exposure time of photosensor region 125), the image data is deconvolved vertically (e.g., along each column of pixels 160) and the deconvolution of each column is stored in a data packet. The deconvolved column data for each column of each photosensor region 125 in the row is added to the data packet, and the data packet, now containing data for each column of each photosensor region in the row, is transmitted to electronic controller 140. Performing the vertical deconvolution prior to sending the data to electronic controller 140 reduces the amount of data that must be transferred via electrical conductors 130, and also reduces the amount of data to be processed and the number of operations to be performed by electronic controller 140. Accordingly, the frame rate of the image-capture system may be increased.

After receiving the data packet containing the deconvolved column data, electronic controller 140 may be configured to horizontally deconvolve the data of the data packet (e.g., to deconvolve the data along a dimension corresponding to the rows of pixels 160 of photosensor regions 125). Alternatively, or additionally, the horizontal deconvolution may be performed on each data packet (e.g., by at least one processing circuit 165) before the data packet is sent to the electronic controller.

In some examples, the deconvolution of each column is stored in a predetermined range of bits within the ordered set of bits comprising the data packet. For example, each pixel column within a row of image-sensor dies 120 may be stored in a respective unique range of bits. Alternatively, the deconvolution of each pixel column may be added to a respective predetermined range of bits that partially overlaps with ranges of bits corresponding to at least one other pixel column. For example, if each photosensor region 125 includes n columns, then the deconvolution of each column of the first photosensor region in a row may be stored in the first n bit positions of the data packet, e.g., in bit positions labeled 0 through n−1. The deconvolution of each column of the second photosensor region (that is, the photosensor region adjacent the first region) in the same row may be stored in bit positions 1 through n, and so on. At bit positions where data from a previous photosensor region is already stored, the data of the present column is added to the existing data. In this manner, a data packet including deconvolved data from each column of each photosensor region 125 in the row is created, and the number of bit positions in at least one dimension of the data packet corresponds to the number of photosensor regions in the row. Other dimensions of the data packet may correspond to a number of color components (e.g., red, green, and blue color components) and/or to a pixel resolution and/or dynamic range for the deconvolved data.

In some examples, a selected subset of image-sensor dies 120 may be configured to operate with a faster frame rate than other image-sensor dies. For example, electronic controller 140 may be configured to send trigger signals to a selected subset of rows more frequently than to other rows. This allows selected portions of device 100 to capture image data at a higher frame rate than other portions. For example, electronic controller 140 and/or data-processing system 170 may be configured to detect that image data from a first subset of image-sensor dies 120 changes significantly from frame to frame, whereas image data from a second subset of image-sensor dies changes little from frame to frame. The controller and/or data processing system may therefore trigger the readout of image data from rows including image-sensor dies 120 of the first subset at a faster rate than data from rows including dies of the second subset.

### F. Illustrative Devices

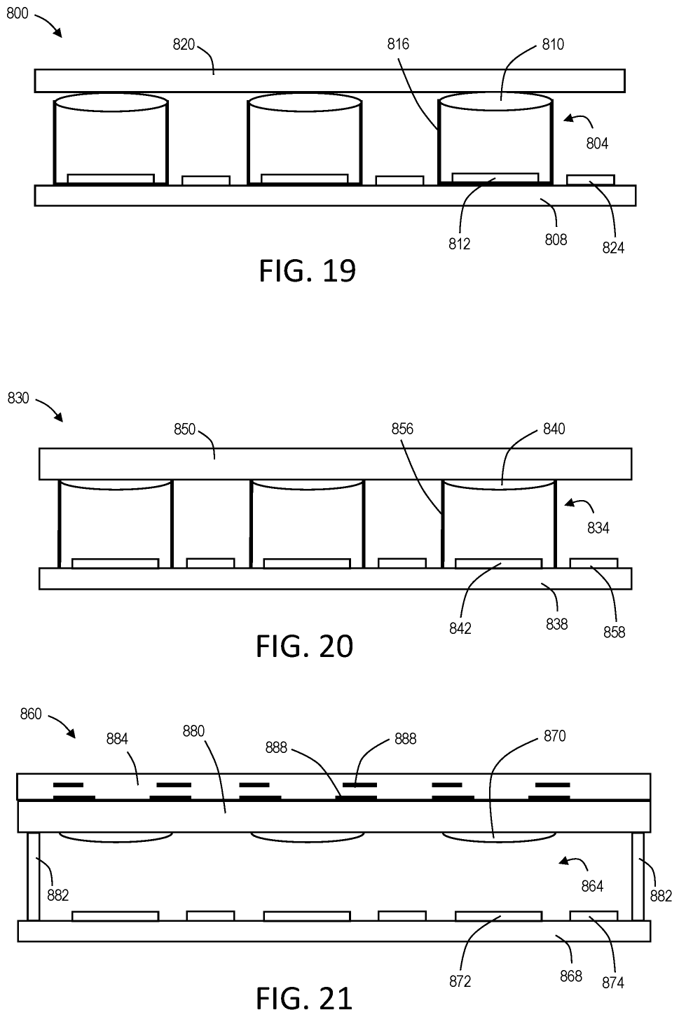

With reference to FIGS. 19-22, this section describes aspects of illustrative display and image-capture devices.

FIG. 19 is a schematic partial side view of an illustrative display and image-capture device 800. Device 800 includes a plurality of microcameras 804 disposed on a substrate 808. In this example, microcameras 804 each comprise an integrated microcamera (e.g., a chip) having a lens 810 held in a fixed position relative to a photosensor region 812 by a support 816 (e.g., a strut, a housing of the microcamera, and/or any other suitable structure). Microcameras 804 support a cover layer 820 above substrate 800. Cover layer 820 comprises a protective layer configured to protect underlying components from damage, and optionally to facilitate device functions such as touch- or hover-sensing, as described elsewhere herein.

In this example, cover layer 820 is supported above substrate 800 only by microcameras 804, but in other examples, additional spacing devices may be included. A plurality of light-emitting regions 824 are disposed on substrate 808 in any suitable pattern.

FIG. 20 is a schematic partial side view of another illustrative display and image-capture device 830. Device 830 includes a plurality of microcameras 834 disposed on a substrate 838. Microcameras 834 each include a microlens 840 configured to direct light toward at least a portion of a photosensor region 842. Microlenses 840 are integral with a cover layer 850. For example, microlenses 840 may be fabricated on and/or within cover layer 850. Microlenses 840 may comprise a microlens array. In some examples, one or more color filters may be integral with the microlens and cover layer (e.g., the filter may be fabricated on and/or within the cover layer).

Cover layer 850 may comprise any material suitable for supporting microlenses 840 while allowing transmission of light for the display and image-capture functions of the device. For example, cover layer 850 may form at least a portion of a protective layer. Alternatively, a protective layer may be disposed on or adjacent a surface of the cover layer.

Cover layer 850 is spaced from substrate 838 by a plurality of supports 856. Supports 856 may comprise any structure(s) suitable for supporting cover layer 850 in a manner that helps to maintain a fixed distance between the cover layer and substrate 838. This allows microlenses 840 to be maintained at a predetermined position and orientation relative to corresponding photosensor regions 812. In this example, one or more supports 856 are disposed adjacent each microcamera 834, but in other examples, the supports may be distributed throughout the device in another suitable arrangement. For example, some microcameras may not have adjacent supports, and/or some supports may be positioned relatively far from any microcamera.

In some examples, at least some of the supports 856 are further configured to shield photosensor regions 812, such that each photosensor region receives light only from the corresponding microlens 840. For example, one or more supports 856 may be disposed adjacent at least some microcameras and configured to shield photosensor region 812 of the associated microcamera from unwanted light (e.g., light passing through lenses of other microcameras or other portions of cover layer 850, light generated by light-emitting regions 858, and/or any other unwanted light).

FIG. 21 is a schematic partial side view of yet another illustrative display and image-capture device 860. Similar to device 830, device 860 includes a plurality of microcameras 864 disposed on a substrate 868, each microcamera including a microlens 870 configured to direct light toward at least a portion of a photosensor region 872. A plurality of light-emitting regions 874 are disposed on the substrate. Microlenses 870 are integral with a cover layer 880.

Device 860 further includes a plurality of supports 882 configured to support cover layer 880 at a predetermined position and orientation relative to substrate 868. Supports 882 are disposed at edge portions (e.g., a periphery) of device 860. In examples wherein supports 882 are disposed only at peripheral portions of device 860, manufacture of the device may be simple relative to manufacture of device 830, which has supports 856 disposed adjacent some or all of its microcameras. However, device 860 optionally further includes additional supports 882 disposed at other portions of the device (e.g., away from the edges). Supports 882 may each have any suitable shape for supporting cover layer 880, such as a column, a block, a wall, and/or any other suitable shape.

Device 860 further includes a mask layer 884 disposed on or adjacent cover layer 880. Mask layer 884 comprises a substantially transparent layer of material having a pattern of opaque masking components 888 configured to block light in a manner that at least partially determines a field of view of a microcamera 834, or of a group of microcameras 834. For example, masking components 888 may comprise one or more annular rings disposed adjacent each microlens 870, such that the masking components effectively create an aperture in front of (e.g., on a light-incident side of) the microlens.

Masking layer 884 may be included in any suitable display and image-capture device. In some examples, a pattern of masking components is included in and/or on a cover layer of the device, rather than in a dedicated masking layer.

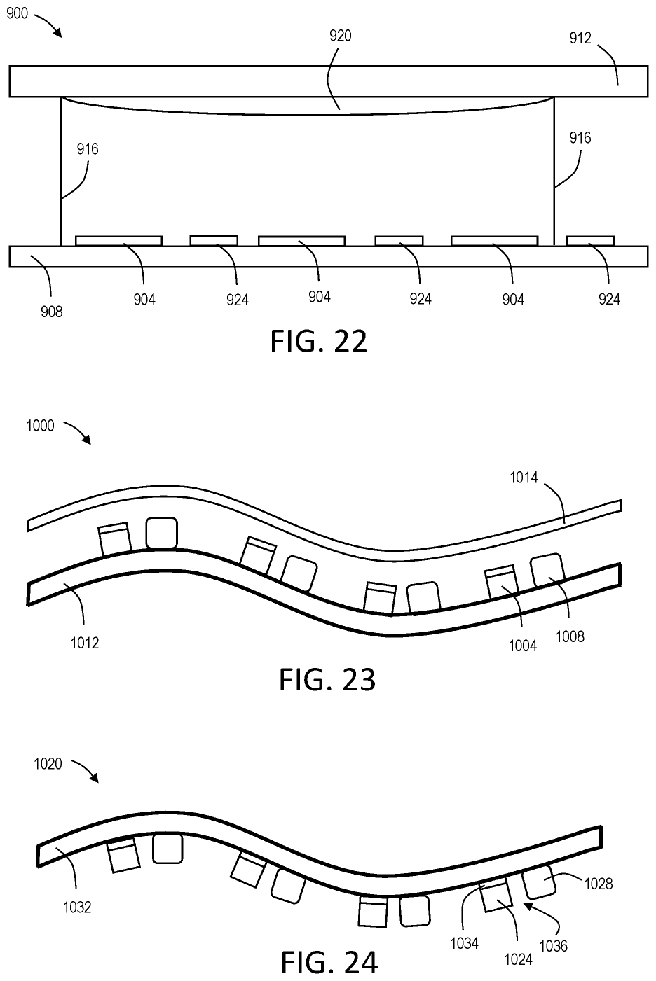

FIG. 22 is a schematic partial side view of yet another display and image-capture device 900. Device 900 includes a plurality of image-sensor dies 904 disposed on a substrate 908. A cover layer 912 is spaced from substrate 908 by supports 916, a low-index encapsulation material, and/or any other suitable structure. At least one lens 920 is disposed at a fixed distance from substrate 908. In the depicted example, lens 920 is formed on cover layer 912, but in other examples, the lenses may be positioned relative to the substrate in another suitable manner. Lens 920 is configured to direct impinging light toward more than one image-sensor die 904. For example, lens 920 may be configured to direct light toward a 3×3 array of nine image-sensor dies 904, as depicted in side view in FIG. 22.

Lens 920 has a large diameter relative to the lens of a microcamera. This allows device 900 to resolve more detail of distant objects optically (i.e., without post-acquisition enhancement) relative to devices using microcameras. However, as a result of the larger size of lens 920, device 900 may be thicker than a microcamera device. Additional optical elements may be included in device 900 to compensate for aberrations in lens 920. Based on the large lens size, device 900 may advantageously be implemented as a relatively large device (e.g., as a television or computer monitor). However, in other examples, device 900 is implemented as a smaller device, such as a smartphone or tablet. To reduce the overall thickness of device 900, it is desirable to minimize the lens thickness, focal length and f-number of lens 920. For this reason, in some examples lens 920 comprises a metalens, which is inherently flat and may have f-numbers as low as, or lower than, f/0.5.

Lens 920 tends to direct some impinging light onto underlying portions of the device where there are no image sensors (e.g., onto spaces on substrate 908 between image-sensor dies 904, onto light-emitting regions 924, etc.). As a result, for each lens 920 of the device, there are generally one or more directions from which impinging light cannot be directed to an image sensor. Accordingly, in the scene being imaged by device 900, regions of space corresponding to those directions are not imaged by the lens in question. To address this problem, image data corresponding to each lens 920 (e.g., signals acquired by the associated image-sensor dies 904) can be combined with image data corresponding to one or more other lenses 920 (e.g., by processing logic of device 900 and/or by a computer). Image data corresponding to two or more lenses can be merged to create an image of the entire scene, with no regions of space missing.

### G. Illustrative Flexible Device

With reference to FIGS. 23-25, this section describes illustrative flexible and/or foldable display and image-capture devices, in accordance with aspects of the present teachings.

FIG. 23 is a schematic partial side view of a flexible display and image-capture device 1000. Device 1000 includes a plurality of image-sensing regions 1004 and a plurality of light-emitting regions 1008 disposed on a flexible substrate 1012. Flexible substrate 1012 may comprise any flexible material(s) suitable for supporting regions 1004 and 1008, such as polymer(s) and/or any other suitable material(s). The flexibility of substrate 1012 allows device 1000 to roll, fold, and/or otherwise assume a non-planar configuration under normal operation, including while displaying and/or capturing images.

In some examples, image-sensing regions 1004 comprise dies, which may also include active matrix circuitry configured to drive display pixels of the device. This may avoid the use of thin-film devices which could malfunction and/or suffer damage when the substrate is deformed (e.g., rolled) in certain ways. However, thin-film devices can be included if desired.

Device 1000 further includes a flexible cover layer 1014 configured to protect underlying components (e.g., regions 1004 and 1008, electrical components, and/or any other device components) while allowing transmission of light for display and image-capture. Cover layer 1014 may comprise a thin flexible glass, a transparent polymer, and/or any other suitable device. Light-emitting regions 1008 are configured to emit light through cover layer 1014. For example, light-emitting regions 1008 may comprise top-emitting microLEDs. Lenses configured to direct light impinging on cover layer 1014 toward image-sensing regions 1004 may be included in device 1000 in any suitable manner (e.g., formed in cover layer 1014, integrated into microcamera chips along with image-sensing regions 1004, mounted above the image-sensing regions, etc.).

FIG. 24 is a schematic partial side view of another flexible display and image-capture device 1020. Device 1020 includes a plurality of image-sensing regions 1024 and a plurality of light-emitting regions 1028 disposed on a flexible substrate 1032. Substrate 1032 is transparent (e.g., a thin flexible glass, transparent polymer, and/or any other suitable material(s)). Light-emitting regions 1028 are configured to emit light through substrate 1032. For example, light-emitting regions 1028 may comprise bottom-emitting microLEDs. Image-sensing regions 1024 are configured to receive light transmitted through substrate 1032. Optionally, lenses 1034 may be configured to direct light impinging on substrate 1032 onto image-sensing regions 1024. In the depicted example, lenses 1034 and image-sensing regions 1024 comprise microcameras 1036.

In some examples, lenses 1034 are fabricated on substrate 1032 (e.g., by microreplication, lithography, and/or any other suitable process(es)) prior to attachment of the image sensors, which can simplify manufacturing. Optionally, lenses may be included between substrate 1032 and light-emitting regions 1028 to at least partially control emission of light from the substrate.

Because substrate 1032 protects image-sensing regions 1024, light-emitting regions 1028, and other components from the environment, there is no need for a transparent cover layer at a light-incident side of the device. This can allow a device having lower bending stresses, relative to a device having a cover layer. Optionally, an encapsulation layer may be disposed on a back side of the device (e.g., with the image-sensing and light-emitting regions disposed between the encapsulation layer and the flexible substrate). In contrast to a front-side cover layer, the optical properties of a back-side encapsulation layer are typically unimportant, which allows use of a greater variety of materials and designs.

In a flexible device, such as devices 1000 and 1020, the relative position and/or orientations of microcameras on the device tends to vary as the device is folded or rolled. Accordingly, the amount of overlap and/or spatial offset between fields of view of adjacent microcameras can change based on the configuration of the substrate. Image-processing algorithms can be used (e.g., in real-time) to compensate for microcamera-to-microcamera alignment and/or position changes. This processing may be performed prior to image reconstruction, and/or at any other suitable point in processing. For example, an angular offset (e.g., a 2-dimensional offset) can be calculated based on a comparison between images acquired by neighboring microcameras, and this offset can be used in certain image-processing algorithms. In this manner, image-processing algorithms including a comparison, combination, and/or calculation involving images acquired by adjacent microcameras can be performed even in a flexible device in which the relative positions of the microcameras changes.

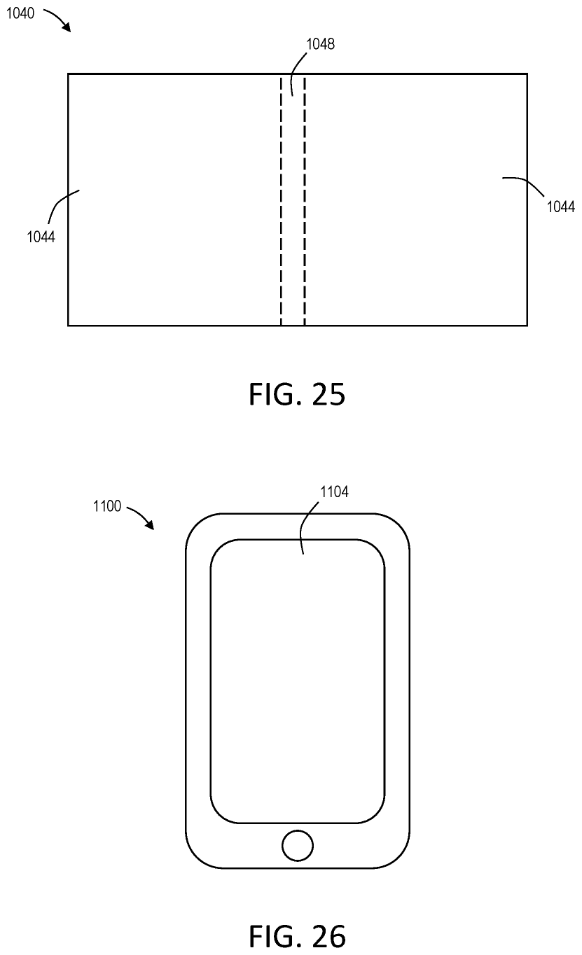

FIG. 25 is a schematic front view depicting a foldable display and image-capture device 1040. Device 1040 comprises a substrate having two rigid zones 1044 spaced from each other by a fold zone 1048. Rigid zones 1044 are configured to remain rigid during normal operation, and fold zone 1048 is configured to fold, bend, roll, and/or otherwise deform during normal operation. For example, fold zone 1048 may be creased, may be perforated, may comprise a relatively flexible material, and/or may otherwise be configured to deform without sustaining damage.

A plurality of image-sensing regions and light-emitting regions may be disposed on rigid zones 1044. Disposing these components on rigid zones 1044 avoids mechanical stress on the components, which can occur if they are disposed on a flexible portion of the device. The rigidity of rigid zones 1044 may also help to ensure that relative positions between microcameras in a same rigid zone remains fixed, which can simplify processing of acquired image data. Light-emitting regions may also extend into the fold zone to achieve a seamless-appearing display, whereas the image-sensing regions do not extend into the fold zone so as to maintain camera alignment and simplify the image processing. The lack of image-sensing capability in the fold zone would typically be invisible to the user.

In the depicted example, fold zone 1048 is disposed between a pair of rigid zones 1044, allowing device 1040 to fold like a book (e.g., with the microcameras and light-emitters facing inward, or facing outward, as desired). In other examples, a foldable device may include any suitable number of fold zones and rigid zones arranged in any other suitable configuration.

### H. Illustrative Mobile Phone

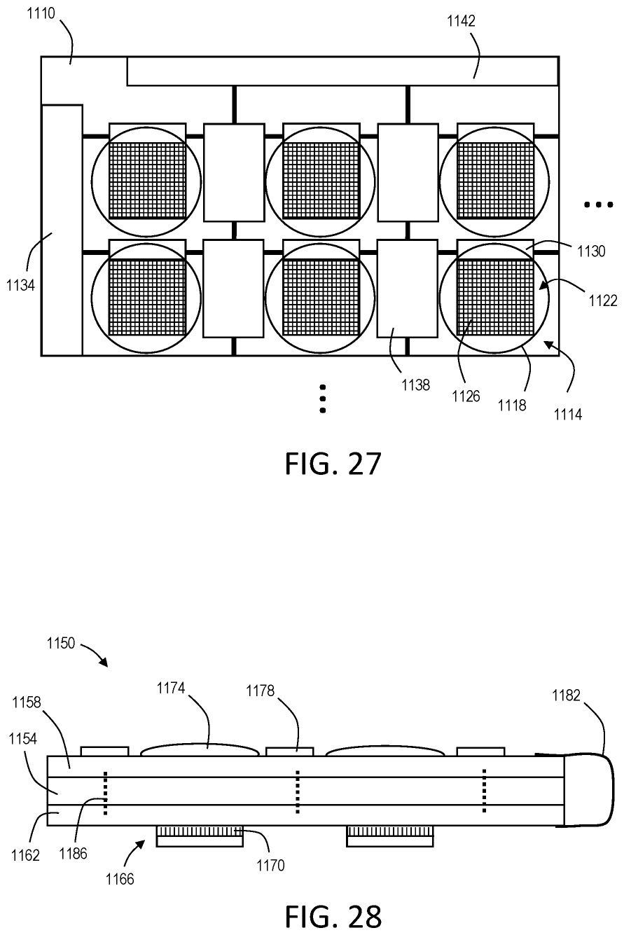

With reference to FIGS. 26-27, this section describes an illustrative mobile phone 1100 (AKA a cellular phone, cell phone, or smartphone) including a display and image-capture device, in accordance with aspects of the present teachings. Aspects of the following description of phone 1100 may also apply to a tablet or other similar mobile digital device. In general, a cell phone or other mobile digital device may include any display and image-capture device(s) described herein. This section describes a non-limiting example.

FIG. 26 is a schematic front view of phone 1100, which includes a display and image-capture panel 1104. In the depicted example, panel 1104 comprises a front-facing display, but in other examples, the phone and panel may have any other suitable form factor(s). In a typical phone, bezel area is needed to house the front-facing camera and other sensors. However, in phone 1100, the camera bezel area can be virtually eliminated because the front-facing camera, as well as any fingerprint scanner, ambient, and/or light sensor, is included within the display itself. Phone control buttons can be incorporated into the integrated image sensors of this invention and/or other sensing means under or on the edge of the display, which can eliminate the need for separate (e.g., mechanical) phone control buttons. Consequently, the entire area of the phone surface can serve as the display.

FIG. 27 is a schematic partial front view of a substrate 1110 of front panel 1104. A plurality of microcameras 1114 are disposed on substrate 1110, each microcamera comprising a lens 1118 and an image-sensing die 1122. Image-sensing die 1122 comprises a photosensing region 1126 (e.g., a CMOS array, CCD array, and/or other suitable light sensor) and a processing circuit 1130. A scan driver electronic controller 1134 is configured to trigger readout of data sensed by microcameras 1118 and/or to otherwise control the microcameras.

A plurality of light-emitting regions 1138 are disposed on substrate 1110. In this example, light-emitting regions 1138 each comprise a red microLED, a green microLED, and a blue microLED (e.g., an RGB pixel). Light-emitting regions 1138 are controlled by a display data driver electronic controller 1142. In some examples, controller 1142 controls light-emitting regions 1138 by transmitting signals to an active matrix circuit integrated into an adjacent image-sensing die 1122.

In this example, a respective microcamera 1114 is disposed adjacent each light-emitting region 1138. In other examples, however, panel 1104 may include fewer microcameras (e.g. microcameras are located every five to eight display pixels). The number of microcameras may be selected based on, e.g., a field of view of each microcamera and a desired resolution for panel 1104 (e.g., a resolution achievable prior to resolution-enhancement processing and/or achievable after resolution-enhancement processing).

### I. Illustrative Device Having Thin-Film Image Circuitry

With reference to FIGS. 28-32, this section describes illustrative display and image-capture devices including layers of thin-film circuitry. In general, the thin-film layers are patterned with circuitry configured to control photosensors and/or light-emitting regions of the device. The thin-film circuitry may comprise metal electrical routing, thin-film transistors, capacitors, resistors, and/or other suitable electrical components. Including circuitry components and/or electrical connections in the thin-film layer(s) can avoid the need for processing circuits to be attached to the substrate (e.g., in a mass transfer or other suitable process). This may simplify manufacture of the device. However, additional circuitry other than the thin-film circuitry may be included if desired (e.g., in dies disposed on top of the thin-film layers or other portions of the substrate).

In some examples, one or more electronic controllers and/or display driver dies are attached to the device and configured to communicate with the circuitry of the thin-film layer(s) (e.g., via conductors embedded in the thin-film layers, and/or any other suitable connections).

FIG. 28 is a schematic partial side view of an illustrative display and image-capture device 1150 comprising a transparent substrate 1154, at least one front thin-film layer stack 1158 disposed on a front side (i.e., a light-incident side) of the substrate, and at least one back thin-film layer stack 1162 disposed on a back side of the substrate. This double-sided structure provides more area for signal routing without interfering with light emission or light sensing, and allows the transparent substrate to provide the lens focal distance of the microcameras. The presence of thin-film layers on both the front and the back of the substrate may allow a balanced mechanical stress on the front and back of the substrate, making the device relatively robust.

A plurality of image-sensor dies 1166 are disposed on a back side of back thin-film layer stack 1162, with photosensor region 1170 of each image-sensor die facing the thin-film layer stack. Back thin-film layer stack 1162 comprises circuitry configured to control photosensor regions 1170. In some examples, the image-sensor dies are formed as flip chips (e.g., using controlled collapse chip connection). Alternatively, the image sensor 1166 may be formed as part of the thin film stack.

Although the example depicted in FIG. 28 has one image sensor die 1166 under each lens 1174, a single image sensor die could alternatively extend under multiple lenses (e.g., one or more image sensor dies could each extend under a plurality of lenses). Extending the image sensor die under multiple lenses would have the advantage of potentially increasing the field of view of the microcamera associated with each lens, simplifying image processing and data routing (because multiple microcameras could be connected to an image sensor processor within the die) and reducing the cost and complexity of device assembly.

Because the image-sensor dies are disposed at a back portion of the device, with the photosensors facing the nearby thin-film layers, they are relatively unlikely to sustain damage during manufacture and use. Accordingly, the image-sensor dies may include little or no packaging.

A plurality of lenses 1174 disposed on a front side of front thin-film layer 1158 are configured to direct light onto photosensor regions 1170. Lenses 1174 direct light through substrate 1154 and thin-film layers 1158 and 1162, which are configured to be transparent to light within the wavelength range expected to be sensed by photosensor regions 1170 (e.g., the visible spectrum).

Because the lenses can be disposed directly on the front-side thin-film layer stack (or on a relatively thin filter layer and/or optical isolation layer disposed between the lenses and the thin-film circuitry), device 1150 has low standoff. Accordingly, device 1150 can be relatively thin compared to other devices. For example, substrate 1154 can have a thickness of one millimeter or less (e.g., 0.55 millimeters), and the thin-film layers can each have a respective thickness of half a millimeter or less (e.g., 0.4 millimeters).

In some examples, the lenses and/or any associated color filters are photoformed on front thin-film layer 1158.

A plurality of light-emitting regions 1178 (e.g., microLED dies) are disposed on a front side of front thin-film layer stack 1158. Front thin-film layer stack 1158 comprises circuitry configured to control the light-emitting regions.

Thin-film layer stacks 1158, 1162 and/or substrate 1154 may include field stop layers, patterned opaque mask components, optical isolation layers, and/or any other suitable components. These components may be configured to reduce unwanted reflection of light within device 1150, define aperture(s) for one or more photosensor regions 1170, shield one or more photosensor regions from unwanted light, and/or to accomplish any other suitable effect. Additionally, or alternatively, one or more color filters may be formed in and/or on the substrate and/or one or both thin-film layers (e.g., such that light is spectrally filtered prior to impinging on the photosensor regions).

Thin-film layer stacks 1158 and 1162 are electrically connected to each other, allowing electrical communication between the circuitry configured to control light-emitting regions 1178 and the circuitry configured to control photosensor regions 1170. This may allow circuitry of the back thin-film layer to at least partially control device components (e.g., light-emitting regions 1178) disposed on the front thin-film layer, and/or may allow circuitry of the front thin-film layer to at least partially control device components (e.g., photosensor regions 1170) disposed on the back thin-film layer. In the depicted example, a flexible printed circuit interconnect 1182 disposed at an edge of the device electrically couples thin-film layers 1158, 1162 to each other. Thin-film layer stacks 1158, 1162 are further electrically connected by electrical vias 1186 through substrate 1154. Electrical vias may, e.g., connect active matrix circuitry disposed in the image-sensor dies to the light-emitting regions, allowing the active matrix circuits to control the light-emitting components. Although the depicted example includes electrical vias and a flexible interconnect at a peripheral portion of the device, other examples may include only the vias or only the flexible interconnect(s), or neither vias nor interconnects. In some examples, a non-flexible interconnect may be used.

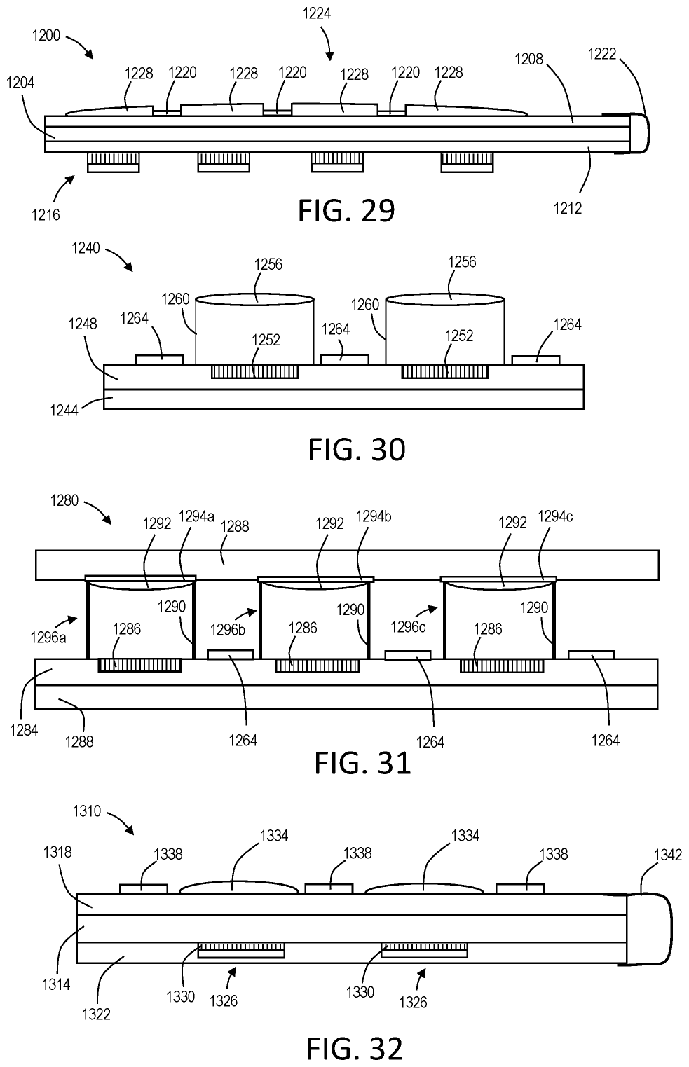

FIG. 29 is a schematic partial side view of another illustrative display and image-capture device 1200. Device 1200 comprises a substrate 1204 having a front thin-film circuitry layer 1208 disposed at a front side of the substrate, and a back thin-film circuitry layer 1212 disposed at a back side of the substrate. Image-sensor dies 1216 are disposed at a back side of back thin-film layer 1212, and light-emitting regions 1220 are disposed at a front side of front thin-film layer 1208. A flexible circuit interconnect 1222 connects front and back thin-film circuitry layers 1208, 1212. In some examples, electrical vias are used instead of, or in addition to, the flexible interconnect.

At least one segmented, and/or perforated, lens 1224 is disposed at a front side of front thin-film layer 1208. Each segmented lens 1224 comprises a plurality of lens segments 1228 each configured to direct light through the substrate and intervening thin-film layers to one or more image-sensor dies 1216. Any suitable number of segmented lenses may be included in device 1200, and each segmented lens may be configured to direct light toward any suitable number of image-sensor dies.

Although the example depicted in FIG. 29 has one image sensor die 1216 under each lens segment 1228, a single image sensor die could alternatively extend under multiple lens segments (e.g., one or more image sensor dies could each extend under a plurality of lenses). Extending the image sensor die under multiple lens segments, the entire lens 1224, or beyond the lens 1224, would have the advantage of simplifying image processing and data routing because multiple microcameras could be connected to a single image sensor processor within the die, and reducing the cost and simplifying the complexity of device assembly. For example, if the image sensor die extended under the entirety of lens 1224, the die would provide a single image treating lens 1224 in combination with the extended die as a single camera.

In some cases, some segments of some lenses do not direct light toward any image-sensor dies. For example, segments near the edges of the lenses may have undesirable curvature.

In some examples, the process of manufacturing device 1200 includes forming whole (e.g., unsegmented) lenses on front thin-film layer 1208 and then creating gaps within the lens, yielding the segmented and/or perforated lenses. The gaps accommodate light-emitting regions 1220 and/or any other suitable device components.

FIG. 30 is a schematic partial side view of yet another illustrative display and image-capture device 1240. Device 1240 comprises a substrate 1244 having a thin-film circuitry layer 1248 disposed at a front side of the substrate. Device 1240 has no thin-film circuitry layers at the back side of the substrate.

Thin-film circuitry layer 1248 includes a plurality of thin-film image-sensor regions 1252 fabricated in and/or on the thin-film circuitry layer (e.g., from amorphous silicon, polysilicon, and/or any other suitable thin-film materials). Image-sensor regions 1252 each comprise multi-pixel image sensors (e.g., CMOS arrays, CCD arrays, and/or any other suitable multi-pixel sensors).

A plurality of lenses 1256 are supported on thin-film layer 1248 by respective supports 1260. In the depicted example, one lens 1256 is disposed above each image-sensor region 1252, but in other examples, more or fewer than one lens per image-sensor region may be provided. Each image-sensor region 1252 and associated lens 1256 forms a multipixel microcamera. Properties of the lens and image sensor are selected such that the microcamera is configured for far-field imaging as well as near-field imaging.

Supports 1260 may further be configured to optically shield the associated image-sensor regions from unwanted light.

A plurality of light-emitting regions 1264 are disposed on thin-film circuitry layer 1248. In some examples, light-emitting regions 1264 are controlled by active matrix circuitry included in thin-film circuitry layer 1248.

FIG. 31 is a schematic partial side view of yet another illustrative display and image-capture device 1280. Like device 1240, device 1280 has a thin-film circuitry layer 1284 disposed at a front side of a substrate 1288. Thin-film circuitry layer 1284 includes a plurality of thin-film image sensors 1286. A transparent cover layer 1288 is supported above thin-film circuitry layer 1284 by a plurality of spacers 1290, which also shield image sensors 1286 from unwanted light. A plurality of lenses 1292 are fabricated on a back side of cover layer 1288 and configured to direct light onto image sensors 1286. In some examples, spacers 1290 are also fabricated onto the back side of cover layer 1288 and adhered to substrate 1288.

In this example, a respective color filter is fabricated on cover layer 1288 along with each lens 1292. A first microcamera 1296a includes a red color filter 1294a, a second microcamera 1296b includes a green color filter 1294b, and a third microcamera 1296c includes a blue color filter 1294c. This allows microcameras 1296a, 1296b, and 1296c collectively to form a RGB image-sensing unit. However, in other examples, microcameras of the device may have different color filters, color filter arrays, or no color filters.

FIG. 32 is a schematic partial side view of yet another illustrative display and image-capture device 1310. Device 1310 includes a transparent substrate 1314, a front thin-film circuitry layer 1318 disposed on a front side of the substrate, and a back thin-film circuitry layer 1322 disposed on a back side of the substrate. A plurality of image-sensor regions 1326 are fabricated on a front side of back thin-film circuitry layer 1322, with photosensors 1330 of the image-sensor regions facing the back side of substrate 1314. Back thin-film layer 1322 comprises circuitry configured to control image-sensor regions 1326.

A plurality of lenses 1334 are disposed on (e.g., fabricated on) a front side of front thin-film layer 1318. Lenses 1334 are configured to direct light onto photosensors 1330. A plurality of light-emitting regions 1338 are disposed on the front side of front thin-film layer 1318. Front thin-film layer 1318 comprises circuitry configured to control light-emitting regions 1338.

A flexible circuit interconnect 1342 electrically couples front thin-film layer 1318 to back thin-film layer 1322. Alternatively, or additionally, electrical vias extending through substrate 1314 may electrically connect the front and back thin-film layers.

### J. Illustrative Integrated Die

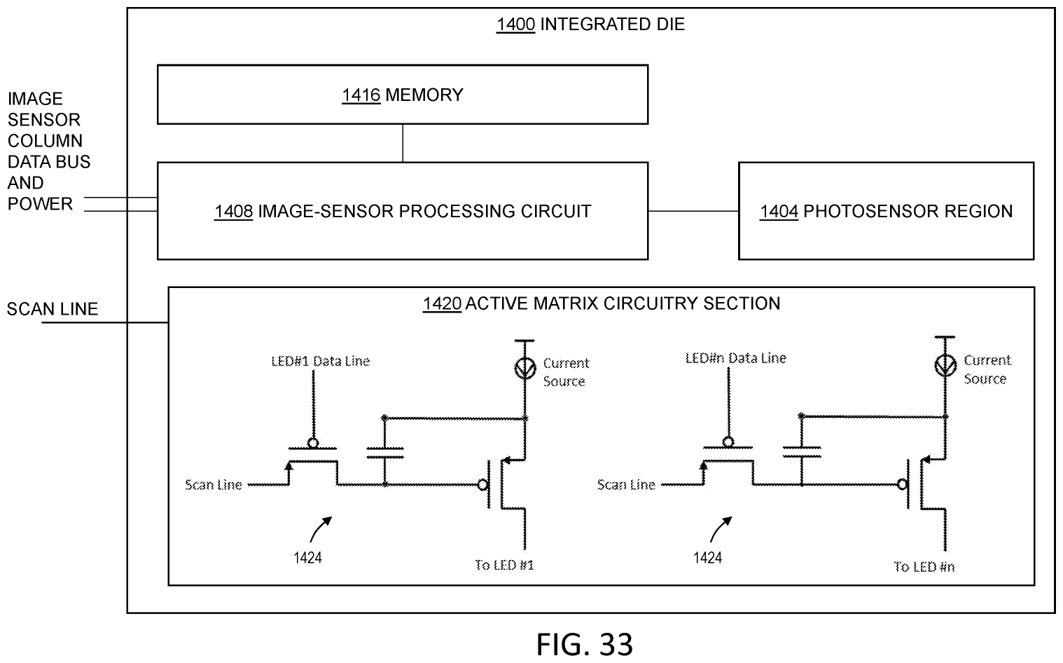

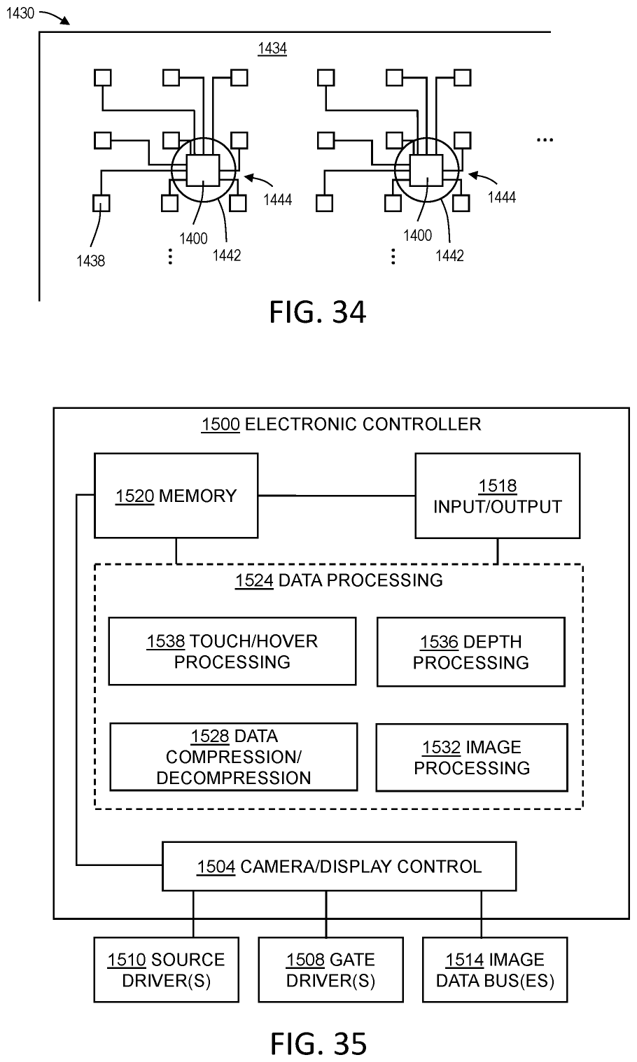

With reference to FIGS. 33-34, this section describes an illustrative integrated die 1400 having a photosensor, image-processing circuitry, and integrated active matrix circuitry configured to control one or more microLEDs or other light-emitting devices. This may be achieved by, e.g., including active matrix display circuitry in an image-sensor die comprising photosensor(s) and associated photosensor processing circuitry. In general, integrated die 1400 may be included in any suitable display and image-capture device comprising one or more image-sensor dies.

Integrated die 1400 allows the circuitry enabling image-capture functions of the device and the circuitry enabling display functions of the device to be located on and/or in the same dies. This allows the substrate of the device to be a simple multilayer circuit board (e.g., with no need for transistors or other components configured to control the light-emitting devices to be disposed on the substrate itself).

In some examples, manufacturing such a device includes attaching the light-emitting devices and the integrated dies to the substrate during the same process (e.g., during a mass transfer of the light-emitters and the integrated dies). This may allow for a relatively simple manufacturing process, compared to the manufacture of display and image-capture devices in which the display-controlling circuitry is applied in a separate step.

FIG. 33 is a schematic diagram depicting integrated die 1400. Die 1400 includes a photosensor region 1404 configured to sense light, and an image-sensor processing circuit 1408 configured to control the photosensor region and/or to process image-sensor signals. For example, processing circuit 1408 may be configured to control photosensor region 1404 based on signals received from an electronic controller of the display and image-capture device (e.g., controller 140, and/or any other suitable controller(s)), and/or to control transmission of data from die 1400 to the electronic controller (e.g., directly and/or via a data bus associated with a subset of dies 1400 of the device, such as a column of dies).

In some examples, image-sensor processing circuit 1408 is further configured to perform image processing on the raw data acquired by photosensor region 1404 (e.g., correction of nonuniformity, optical distortion, gain, and/or aberrations; noise reduction; resolution enhancement pre-processing; data compression, encoding, and/or timing; and/or any other suitable processing).

Image-sensor processing circuit 1408 is in communication with a memory 1416. Memory 1416 may store one or more parameters and/or algorithms used by circuit 1408 to process data acquired by photosensor region 1404 prior to transmission of the data to the electronic controller. In some examples, parameters stored in memory 1416 include calibration parameters associated with photosensor region 1404. The calibration parameters for each photosensor region 1404 of the display and image-capture device may be determined independently.

Die 1400 further includes an active matrix circuitry section 1420 comprising one or more active matrix circuits 1424 each configured to drive a respective light-emitting device, such as a microLED. Active matrix circuit 1424 may comprise any suitable circuit for addressing the associated light-emitting device in an active manner (e.g., rather than a passively addressing the display pixels). For example, active matrix circuit 1424 may comprise a thin-film transistor circuit (e.g., silicon thin-film transistor circuit, and/or any other suitable circuit). An example circuit is depicted in FIG. 33, but in general any suitable circuit may be used. Active matrix circuits 1424 of the display and image-capture device perform the display function(s) of the device in an active matrix display scheme.

In the depicted example, active matrix circuits 1424, image-sensor processing circuit 1408, and photosensor region 1404 are all disposed on a same die 1400. In other examples, these components may be disposed on two or more separate integrated-circuit dies. For example, the photosensor can be disposed on a first die, and the active matrix circuit(s) and the image-sensor processing circuit can be disposed on a second die, and the device includes a plurality of pairs of first and second dies.

FIG. 34 is a schematic partial front view of an illustrative device 1430 including a plurality of integrated dies 1400 disposed on a substrate 1434. In the depicted example, each die 1400 is coupled to nine microLEDs 1438. Accordingly, each die 1400 includes nine active matrix circuits 1424 (see FIG. 33). In other examples however, each die may be configured to control more or fewer microLEDs. In some cases, each die of the device does not control the same number of microLEDs. One diode pole of each microLED is grounded, or connected to another conductor, e.g. a current source line, not shown in FIG. 34.

A respective lens 1442 is disposed above each die 1400, such that the lens and the photosensor of the die comprise a microcamera 1444 controllable by processing circuitry of the die.

### K. Illustrative Electronic Controller

With reference to FIG. 35, this section describes an illustrative electronic controller 1500 for a display and image-capture device.

FIG. 35 is a schematic diagram depicting illustrative elements of electronic controller 1500. Controller 1500 may comprise any suitable processing logic and/or other electrical components configured to carry out the example functions described herein. Controller 1500 may be disposed at any suitable location on a display and image-capture device. In some examples, controller 1500 is disposed at a peripheral portion of the device, such as at an edge of the device, or at a back surface of the device near the edge. In these locations, there is typically enough space for the controller's volume, and the controller generally does not obscure the device display or intrude on the device's field of view. In some examples, controller 1500 is not disposed directly on the device itself, but is coupled to the device by electrical cables, flexible printed circuit, or other suitable connections.

Controller 1500 includes a camera and display control system 1504 configured to read data acquired by image sensors (e.g., microcameras) of the device and to selectively activate display pixels (e.g., microLEDs and/or other suitable light-emitting devices) of the device. In this example, control system 1504 controls the microLEDs by controlling gate drivers 1508 and source drivers 1510 associated with the microLEDs. Any suitable number of gate drivers and source drivers may be used based on the size of the device and/or other suitable factors.

Control system 1504 is configured to receive microcamera image data from one or more data buses 1514. Each data bus is associated with a subset (or all) of microcameras of the device. For example, each row of microcameras on the device may be associated with a data bus configured to facilitate transfer of data acquired by that row of microcameras to control system 1504. Alternatively, or additionally, each column of microcameras or cluster of microcameras may be associated with a data bus configured to facilitate data transfer of the microcameras in that column or cluster.

In some examples, the data buses are omitted, and control system 1504 receives image data directly from the image sensors and/or from processing logic located at each image sensor.

Control system 1504 may be configured to control the relative timing of activation of display pixels and activation of microcameras of the device. In some cases, for example, control system 1504 controls the display pixels and microcameras such that the display pixels are turned off when the microcameras are sensing image data, and the microcameras are turned off (e.g., configured to not sense data) when the display pixels are turned on. This avoids contrast loss and/or other adverse effects in the acquired image data, which might otherwise be caused by reflection within the device of light emitted by the display pixels. For example, in devices wherein the display pixels and image sensors are disposed underneath a protective layer, a portion of the light emitted by the display pixels may reflect from the protective layer and be sensed by the image sensors. Turning off the image sensors while the light is being emitted avoids this problem.

The complementary on-off cycles of the display pixels and microcameras can be sufficiently fast (e.g., high in frequency) that video displayed and recorded by the device exhibit no observable flicker. A suitable frequency may be selected based on the context in which the device is used, which may determine how much noticeable flicker (if any) is acceptable. For example, in some cases the display pixels and/or microcameras alternate at a frequency of at least 30 Hz. In some cases, the display pixels and microcameras alternate at a greater rate, such as 60 Hz, 100 Hz, 120 Hz, or more. The display and image-acquisition periods need not be equal.

In some examples, all display pixels of the device are turned off during image acquisition. In other examples, only a portion of the display pixels are turned off during image acquisition (e.g., only display pixels disposed on one or more regions of the device, only display pixels generating light of a certain color, and/or any other suitable subset of display pixels).

Control system 1504 may further be configured to transmit command signals to the display pixels and/or microcameras configured to effect a mode of operation of the display pixels and/or microcameras. As described above, modes of operation may include two-dimensional image sensing, three-dimensional image sensing, touch-sensing, and/or any other suitable mode. In some examples, control system 1504 is configured to control the display pixels and/or microcameras according to a mode of operation (determined by, e.g., user input), but does not actually transmit a mode-switching signal to the display pixels and/or microcameras.

Controller 1500 further includes one or more input/output systems 1518 configured to facilitate transfer of data via input and/or output hardware of the device (e.g., USB, HDMI, DisplayPort, and/or any other suitable data transfer devices). For example, input/output system may be configured to receive video data from a video input device and to communicate the received video data directly or directly to control system 1504, which controls display pixels such that the received video images are displayed on the device. Alternatively, or additionally, input/output system 1518 may be configured to transfer a video stream (or recorded video data) acquired by the display and image-capture device to another device via video output hardware.

In some examples, controller 1500 is configured to interface with a computing device (e.g., a host computing device) via input/output system(s) 1518. In this configuration, the host computing device provides video input data and/or receives a video stream captured by the display and image-capture device. In some cases, the host computing device provides mode signal(s) to controller 1500 based on an application being executed by the host computing device. In response, controller 1500 provides data processing system 1524 the received mode and/or associated formatting parameters.

For example, if the host computing device application requires a biometric readout, the host computing device provides video input such that a fingerprint scan area (e.g. box) is displayed on the display and image-capture device. The host computing device may additionally trigger the display and image-capture device to capture fingerprint image data in the region of the display corresponding to the displayed box or zone. The host computing device receives the captured fingerprint scan data and uses it in the running host computer application.

In examples wherein controller 1500 interfaces with a computing device, the computing device may perform at least a portion of data processing, memory and control functions normally performed by the controller. This allows the computing device and controller 1500 to collectively perform the required control functions for the display and image capture device. In this case, controller 1500 may be configured for less functionality than would otherwise be needed.

In some examples, input/output systems 1518 are further configured to communicate with one or more accessories usable with the display and image-capture device. For example, input/output systems 1518 may be configured to receive data from an external device configured to install or update firmware, to unlock the device based on a biometric scan, and/or perform any other suitable function.

Controller 1500 further includes a memory 1520 configured to store data. For example, image data read by control system 1504 may be stored in memory 1520 (e.g., prior to being processed by one or more data processing systems 1524, while being processed, and/or after being processed and prior to being transferred off the device by input/output system 1518). The number of images (e.g., video frames) storable in memory 1520 may depend on the resolution of the acquired images. For example, in some cases memory 1520 is configured to store only one high-resolution image frame, or several low-resolution video frames. Additional memory may be coupled to controller 1500 if, e.g., on-device storage of a plurality of processed video frames is desired.

Memory 1520 may further include one or more parameters used by processing systems 1524 to perform image processing and/or other suitable processes, and/or any other suitable data.

Data processing (e.g., image processing, data compression, and/or any other suitable processing) is performed by data processing system 1524. Data processing system 1524 may include any suitable processing logic, including hardware and/or software, configured to perform these functions. Example modules of data processing system 1524 configured to perform illustrative functions are described below. Each module may comprise any suitable hardware and/or software, and in some cases share common hardware and/or software.

Data processing system 1524 includes a data compression/decompression module 1528. In devices wherein sensed image data is acquired by control system 1504 from multiple subsets of microcameras in parallel, data compression/decompression module 1528 may be configured to decompress and/or decode the parallel data. Data compression/decompression module 1524 may further be configured to compress video data acquired and/or processed by the device prior to transferring the video data off the device via input/output system 1518.

In some examples, data compression is performed by the processing logic of microcameras rather than (or in addition to) by module 1528 of controller 1500. This can make data flow from the microcameras to the controller more efficient. Without compression at the microcameras, data flow from the microcameras to the controller is high. The data bandwidth of each data line (e.g., each electrical conductor on the device substrate) is limited by electrical characteristics (e.g., RC characteristics) of the data line. Data compression at the microcamera can reduce the amount of bandwidth and the number of parallel data lines needed to transmit data to the controller at an acceptable rate. Data compression performed at the microcameras may be lossless (e.g., a Lempel-Ziv-Overhumer compression algorithm, a run length encoding algorithm, and/or any other suitable algorithm) to avoid adding noise to the image data prior to processing of the image data at controller 1500. In some examples, the amount of data transmitted from the microcameras to the controllers is reduced by taking advantage of the fact that image data acquired by adjacent microcameras are generally geometric translations of each other. Accordingly, at least some microcameras need not send the actual image data they have sensed, but instead can determine a difference between their sensed image data and the image data sensed by a nearby reference microcamera, and send only the determined difference to the controller. In other words, the controller receives all data obtained by a plurality of reference microcameras, but from the remaining microcameras receives only the data not already represented in the reference microcamera data. This may be a suitable method for reducing dataflow to the controller if introduction of noise into the data can be avoided.

Data processing system 1524 further includes an image processing module 1532 configured to perform image-processing on image data acquired by the device. For example, image processing module 1532 may perform resolution-enhancing techniques on the acquired data, as described elsewhere herein. Image processing module 1532 may be configured to merge respective images acquired by different microcameras or microcamera clusters (e.g., having overlapping fields of view), to reduce noise (e.g., temporal denoising, spatial denoising, 3D denoising, and/or any other suitable noise reduction), to convert detected RGB values to another color space (e.g., luminance and/or chrominance), and/or to perform any other suitable processing.

Data processing system 1524 further includes a depth processing module 1536 configured to perform data processing and/or other functions related to the depth-sensing (AKA light-field) function of the display and image-capture device. For example, module 1536 may be configured to construct, based on data acquired by the microcameras, a depth map of objects within a field of view. For example, a microcamera stereo pair may be used to create a depth map. Alternatively, a depth map may be generated from the light field computed from several microcameras. An image having a desired focal distance and/or depth of field may be calculated from the light field. In some examples, a stream of images constructed by depth processing module 1536 is transmitted off-device via input/output system 1518 as video output, and/or displayed on the device as a video by control system 1504.

Alternatively, or additionally, module 1536 may be configured to analyze the 3D images to determine depth map information related to the images (e.g., a depth of one or more objects in the image, and/or any other suitable information).

Data processing system 1524 further includes a touch/hover module 1538 configured to facilitate touch-sensing and/or hover-sensing features of the device, as described above with reference to FIG. 11. For example, module 1538 may be configured to recognize an object touching or hovering over the device based on image acquired by one or more microcameras, and to cause the device (or a computer in communication with the device) to perform an appropriate reaction in response to the sensed object. Module 1538 may be configured to identify characteristics of the sensed object (e.g., using image recognition, machine learning, and/or any other suitable method). For example, module 1538 may be configured to identify a fingerprint of a finger hovering over or touching the device. This may enable the device to be locked and/or unlocked based on recognition of a fingerprint of an authorized user.

### L. Illustrative Method for Obtaining Calibration Data

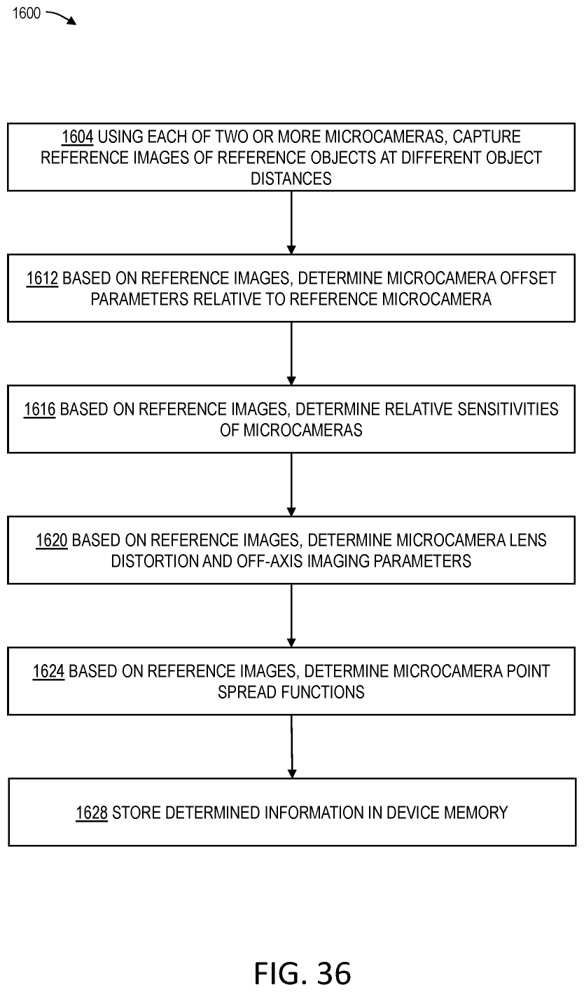

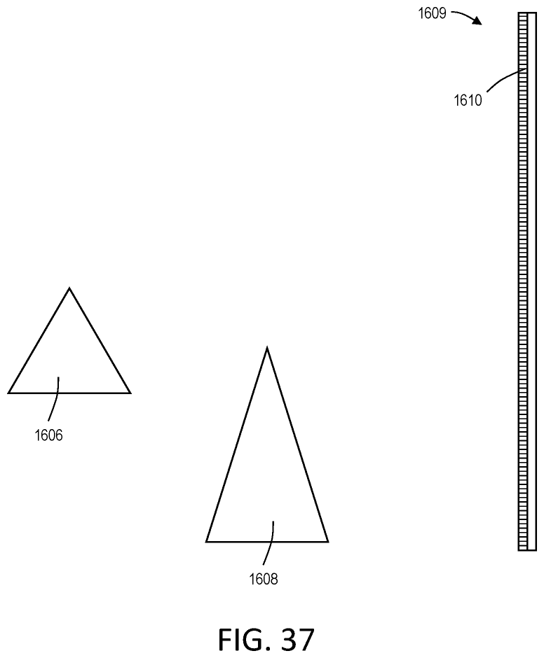

With reference to FIGS. 36-37, this section describes an illustrative method 1600 of determining data calibration parameters (AKA correction parameters) of a display and image-capture device, in accordance with aspects of the present teachings. In general, determining the calibration parameters includes comparing reference images obtained by a subset or all microcameras of the device, and determining information about microcamera sensitivities, aberrations, point spread functions, spatial offsets between microcameras, and/or other suitable microcamera characteristics, based on the compared reference images. The calibration parameters are stored in a memory of the device (e.g., memory 1520 of electronic controller 1500 or memory of the microcamera image sensor and processing die) and utilized to perform image processing on image data acquired by the display and image-capture device. For example, the calibration parameters may be used for image reconstruction, resolution enhancement, noise reduction, and/or any other suitable process.

Method 1600 may be performed at any suitable time. For example, method 1600 may be performed to obtain calibration parameters shortly after manufacture of the device (e.g., during a quality inspection), after purchase and/or installation of a device, periodically during the lifetime of the device, in response to changes in device image quality, and/or at any other suitable time.

Aspects of display and image-capture devices and associated methods described elsewhere herein may be utilized in the method steps described below. Where appropriate, reference may be made to components and systems that may be used in carrying out each step. These references are for illustration, and are not intended to limit the possible ways of carrying out any particular step of the method.

FIG. 36 is a flowchart illustrating steps performed in calibration method 1600, and may not recite the complete process or all steps of the method. Although various steps of method 1600 are described below and depicted in FIG. 36, the steps need not necessarily all be performed, and in some cases may be performed simultaneously or in a different order than the order shown.

At step 1604, method 1600 includes capturing at least a first image frame using a first microcamera and at least a second image frame using a second microcamera. In this example, each microcamera of the device is used to capture one or more respective image frames. This may allow calibration parameters for the entire device to be calculated. In other examples, calibration parameters are determined using only a subset of the microcameras.

Each microcamera used at step 1604 captures a respective reference image of a scene including at least two reference objects disposed at different object distances from the device. For example, each microcamera may capture a reference image including a first reference object disposed at a first location relative to the device and a second reference object disposed at a second location relative to the device. This situation is depicted schematically in FIG. 37, which is a side view depicting first and second reference objects 1606 and 1608 disposed at different locations relative to a device 1609 including a plurality of microcameras 1610.

Alternatively, or additionally, each microcamera may capture a first reference image including a reference object disposed at a first location relative to the device, and a second reference image in which the reference object is disposed at a second location relative to the device (i.e., the reference object is moved between acquisition of the first and second images).

Including reference objects at two or more object distances allows certain microcamera properties (e.g., focal properties of microcamera lenses, alignment of microcamera lenses, field of view offsets, distance-dependent point spread functions, etc.) to be calculated. Obtaining microcamera point spread functions and optical properties at several distances and storing can significantly accelerate the computation of a reconstructed high resolution image, because image reconstruction algorithms typically depend on the depth of objects within the field of view.

At step 1612, method 1600 includes determining, based on the reference images, offset parameter(s) of a plurality of microcameras relative to at least one reference microcamera. For example, one microcamera of the device may be selected as a reference microcamera, and offset parameters are determined for each of the other microcameras of the device relative to the selected reference microcamera. Alternatively, or additionally, each cluster of microcameras may have a reference microcamera, and offset parameters relative to the reference microcamera are determined for each of the other microcameras of the cluster.

Offset parameters include parameters describing a relative spatial offset (e.g., a translational offset and/or a rotational offset) of each microcamera relative to the reference microcamera. The offset parameters may allow, e.g., calculation of a difference in field of view and/or image frame acquired by each microcamera compared to the reference microcamera. This information may be utilized to perform merging of images acquired by different microcameras, resolution enhancement, on-chip data compression, and/or any other suitable processing.

At step 1616, method 1600 includes determining, based on the reference images, information about the relative sensitivities of each microcamera compared to the reference microcamera. The relative sensitivity information can be used to identify non-uniformities in the sensitivity of each microcamera to incident light, allowing nonuniformity correction to be applied to the acquired image data.

At step 1620, method 1600 includes determining, based on the reference images, parameters characterizing microcamera lens distortion, off-axis imaging parameters, and/or any other suitable optical parameters of each microcamera.

At step 1624, method 1600 includes determining, based on the reference images, a point spread function for each microcamera. The microcamera point spread function can be a function of microcamera field angle due to lens aberrations. For example, an image of a point source may be blurrier toward the edges of the field view than at the center of the field of view or on axis.

At step 1628, method 1600 includes storing the information determined at steps 1612-1624 (e.g., calibration parameters, point spread functions, and/or other suitable information) in a memory store of the device. The stored information can be accessed by an electronic controller device, and/or an external data processing system in communication with the device, to perform image processing on image data acquired by the device.

In some examples, step 1628 includes calculating correction factors based on the calibration data, and storing the correction factors in the device memory along with the calibration data. For example, a sensitivity nonuniformity correction factor may be determined for each microcamera based on the relative sensitivity information determined at step 1616, and the correction factor may be stored in device memory along with (or instead of) the relative sensitivities. In other examples, method 1600 does not include determining the correction factors based on the calibration parameters. For example, the step of determining the correction factors may be performed as needed when the device is used to capture images.

### M. Illustrative Method for Capturing Video Image

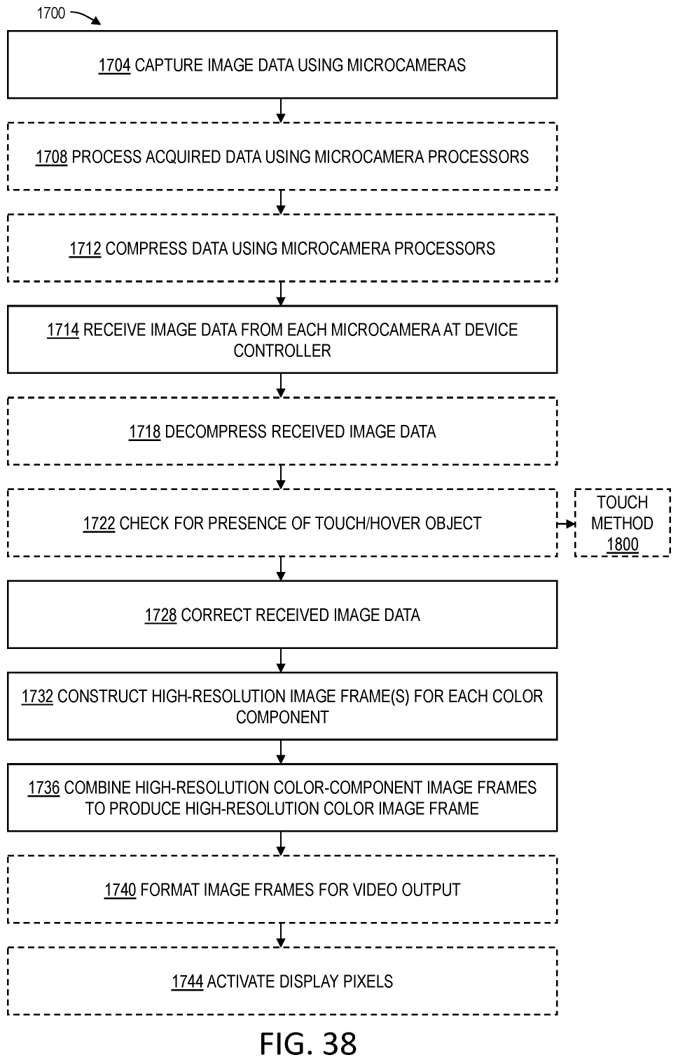

With reference to FIG. 38, this section describes an illustrative method 1700 for capturing video image(s) (e.g., one or more video image frames) using an image-capture and display device, in accordance with aspects of the present teachings. Optionally, the method further includes displaying one or more images (e.g., still images and/or video) using the display of the device.

Method 1700 generally includes performing at least some image processing on acquired images, while adding relatively little noise to the acquired images prior to image processing.

Aspects of display and image-capture devices and associated methods described elsewhere herein may be utilized in the method steps described below. Where appropriate, reference may be made to components and systems that may be used in carrying out each step. These references are for illustration, and are not intended to limit the possible ways of carrying out any particular step of the method.

FIG. 38 is a flowchart illustrating steps performed in method 1700, and may not recite the complete process or all steps of the method. Although various steps of method 1700 are described below and depicted in FIG. 38, the steps need not necessarily all be performed, and in some cases may be performed simultaneously or in a different order than the order shown.

At step 1704, method 1700 includes capturing ambient image data (e.g., image data corresponding to a scene within the field of view of the device) using a plurality of microcameras (and/or other suitable image-sensing devices) disposed on the device. The image capture by each microcamera may be triggered by a command signal received from an electronic controller of the device. The command signal may be configured to control the timing and/or other suitable characteristics of image data acquisition of microcameras on the device. For example, the command signal may determine a time at which a physical or electronic shutter of each microcamera opens, an exposure time of each microcamera, a portion of the photosensor region of each microcamera used to acquire image data, and/or any other suitable characteristic. The command signal may in some cases be configured to trigger only a subset of microcameras to capture an image.

At step 1708, method 1700 optionally includes processing the data sensed by one or more microcameras using a processing circuit disposed at or adjacent the microcamera (e.g., on a same die as the microcamera, on a die adjacent the microcamera, on a thin-film layer, and/or at any other suitable location on the device other than at the main electronic controller). For example, a nonuniformity correction may be applied to the sensed data by the microcamera processing circuit. Suitable correction factors may be stored at the microcamera processing circuit, received from the electronic controller, and/or accessed in any other suitable manner.

At step 1712, method 1700 optionally includes compressing the data sensed by one or more microcameras using a processing circuit disposed at or adjacent the microcamera. Step 1712, if performed, is generally performed after any processing performed by the microcamera processing circuit and prior to transmitting any data to the electronic controller. In some examples, data compression at step 1712 is performed by a processing circuit associated with a group of microcameras (e.g., a row, column, and/or cluster).

At step 1714, method 1700 includes receiving image data from each microcamera at the electronic controller of the device (e.g., after any optional processing and/or compression has been performed on the image data). The image data may be received at the electronic controller directly from each microcamera and/or via one or more data buses associated with subsets of microcameras.

At step 1718, method 1700 optionally includes decompressing the received image data at the electronic controller. For example, step 1718 may be performed if optional data compression was performed at step 1712. In some examples, it is not necessary to decompress the data at step 1718 even if it was compressed at step 1712. For example, in some cases further processing can be performed on the compressed data prior to decompression, or the data is stored or transferred to another device prior to decompression.

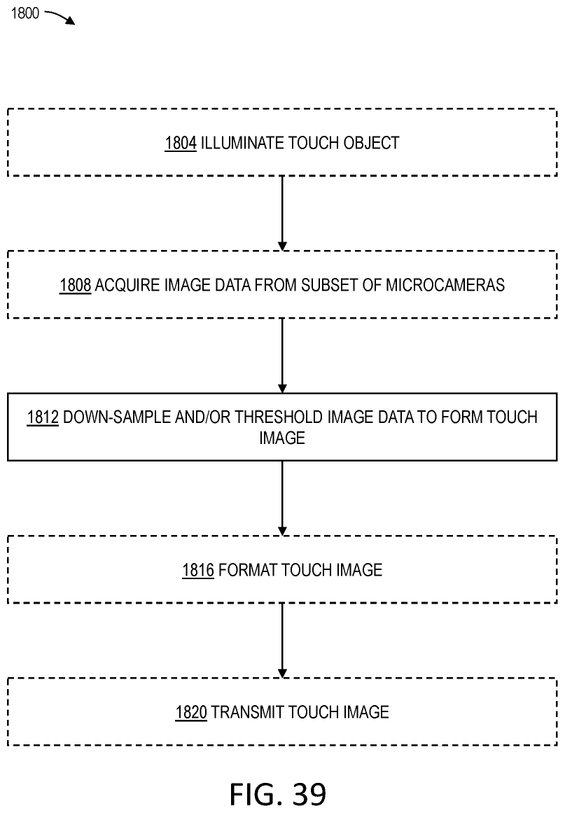

At step 1722, method 1700 optionally includes checking for the presence of an object touching (or hovering) over the display and image-capture device (e.g., an object being used for touch- or hover-sensing functions of the device) using the electronic controller. In response to detecting such an object, at least a portion of the device may switch to a touch-sensing mode of operation. A method for touch-sensing operation is described below with reference to FIG. 39.

Detecting one or more touching or hovering objects at step 1722 may be accomplished in any suitable manner. In some examples, detecting an object includes determining that an object appearing in the image data satisfies one or more predetermined criteria. Suitable criteria may include occupying at least a predetermined fraction of the image frame, and/or at least a predetermined fraction of a field of view of a predetermined portion of the device, and/or being within a predetermined distance of the display and/or a central axis of the display. Alternatively, or additionally, detecting the object may include performing image recognition on the acquired image data to recognize an object (e.g., a finger, a stylus, and/or any other suitable object) based on reference data stored at the electronic controller.

In some examples, a touch or hover object can alternatively or additionally be detected without reference to the acquired image data (e.g., using a proximity sensor configured to detect the object, using a capacitive sensor disposed on the display, and/or by any other suitable method).

If a touching or hovering object is detected at step 1722, the device may switch to a touch mode. In this case, the device stops or suspends performance of method 1700 and switches to performance of a touch-sensing mode, such as method 1800 described below with reference to FIG. 39. If no touching object is detected at step 1722, the device continues to perform method 1700. In some examples, if a touching or hovering object is detected, the device may stop or suspend method 1700 for only a portion of the display and image-capture device (e.g., a touch-mode zone), and method 1700 may continue outside the touch-mode zone.

At step 1728, method 1700 includes performing any suitable corrections on the received image data. Suitable corrections may include nonuniformity corrections, geometrical corrections (e.g., distortion, rotation, and/or translation corrections), and/or any other suitable corrections. In some examples, at least some of the corrections are performed using data obtained by method 1600 and/or another suitable method for obtaining calibration data. In some examples, no corrections are performed at step 1728.

At step 1732, method 1700 includes constructing at least one high-resolution image frame for each color component of the received (and optionally, corrected) image data. In general, the received image data comprises one or more components of a color space, such as a suitable RGB or YUV color space, and/or any other suitable space. The color components for which high-resolution frames are constructed at step 1732 may be the same color components that were sensed by the microcameras—for example, the microcameras may have sensed RGB color components (e.g., using single-color microcameras and/or microcameras having color filter arrays), and step 1732 may comprise constructing a red high-resolution frame, a green high-resolution frame, and a blue high-resolution frame. Alternatively, the image data may be converted to another color space prior to construction of the high-resolution frames at step 1732. For example, sensed RGB color components may be converted to luma and chrominance at the electronic controller, and respective high-resolution image frames may be constructed for each of the luma and chrominance components at step 1732.

Constructing a high-resolution image frame for a color component may include performing interpolation, noise reduction, super-resolution, and/or deconvolution using overlapping image data from a plurality of microcameras and suitable point spread function(s) (e.g., point spread functions determined using a calibration data method such as method 1600).

In examples wherein the device functions as a light-field camera, step 1732 may include constructing one or more high-resolution image frames for each color component, each frame comprising an image having a respective selected depth of field and/or focal distance.

At step 1736, method 1700 includes combining the high-resolution image frame constructed at step 1732 for each color component to produce a high-resolution color image frame. This can include one or more high-resolution color images having a selected depth of field and/or focal distance(s), if depth-sensitive image data was acquired at step 1704. Optionally, noise-reduction processes may be performed on the high-resolution color image frame(s) at step 1736.

At step 1740, method 1700 optionally includes formatting the high-resolution color image frame(s) into a suitable format for video output (e.g., via a data port of the device such as USB, an HDMI port, a DisplayPort port, and/or any other suitable interface). This can allow video frames obtained using method 1700 to be viewed (e.g., in real time) on another device, and/or on the display and image-capture device. In some examples, formatting the high-resolution color image frame(s) includes compressing the image frame data.

Method 1700 can be performed repeatedly to rapidly obtain a succession of image frames comprising a video. In some examples, a first image frame can be received and processed at the controller (e.g., steps 1714-1744) while data corresponding to a second image frame is sensed and/or processed at the microcameras (e.g., steps 1704-1712).

At step 1744, method 1700 optionally includes activating a plurality of display pixels of the device to display an image (e.g., an image received at an input of the device) and/or other suitable pattern of pixels. That is, the display of the device may be used at generally the same time the device is capturing video and/or still images. As described above, however, in some cases the display pixels are activated only while the microcameras are not sensing image data (e.g., while microcamera shutters are closed and/or while the microcameras are otherwise inactive). In this case, the device switches between activating display pixels and activating microcameras at a high frequency, so that neither the display nor the captured video exhibit noticeable flicker. In some examples, the displayed image frame rate should be at least 60 Hz to avoid flicker. However, higher displayed image frame rates may be necessary to avoid flicker, depending on the display-image capture duty cycle.

### N. Illustrative Touch-Sensing Method

With reference to FIG. 39, this section describes an illustrative method 1800 for sensing one or more objects touching and/or hovering over a display and image-capture device, in accordance with aspects of the present teachings. Method 1800 may, for example, be performed by a device (possibly automatically) in response to detecting the presence of a touching or hovering object at step 1722 of method 1700. This allows the device to be used for a touch-sensitive function (e.g., as a smartboard, for a game, and/or any other suitable function). A software application running on the device and/or a computer coupled to the device be configured to perform one or more actions in response to touch object information sensed by method 1800. For example, a smartboard application may be configured to cause display pixels of the device to selectively be activated in locations where the touch object has been sensed.

In general, method 1800 can be used to sense more than one touching and/or hovering object simultaneously or nearly simultaneously. Accordingly, method 1800 is a multi-touch sensing method.

Aspects of display and image-capture devices and associated methods described elsewhere herein may be utilized in the method steps described below. Where appropriate, reference may be made to components and systems that may be used in carrying out each step. These references are for illustration, and are not intended to limit the possible ways of carrying out any particular step of the method.

FIG. 39 is a flowchart illustrating steps performed in method 1800, and may not recite the complete process or all steps of the method. Although various steps of method 1800 are described below and depicted in FIG. 39, the steps need not necessarily all be performed, and in some cases may be performed simultaneously or in a different order than the order shown.

At step 1804, method 1800 optionally includes illuminating sensed touch or hover object(s) (hereinafter referred to as touch objects). A touch object, when near enough to the device to be detected, typically blocks at least some ambient light from reaching nearby microcameras. This can result in low light levels and an unpredictable light spectrum and/or intensity being sensed by the nearby microcameras, which can make it difficult for the device to perform touch-sensing functions. Illuminating the touch object at step 1804 can prevent this problem. The touch object may be illuminated by display pixels of the device and/or by one or more secondary light-emitting pixels (e.g., infrared LEDs) disposed on the device.

In some cases, illumination is provided only by pixels located near a detected location of each touch object. This allows other portions of the device to continue to display images in a normal fashion. The touch object blocks some or all of the illuminating light, preventing the illuminating light from disrupting viewers' perception of the display. Finger touch motion vectors can be used to help predict where local illumination is needed or beneficial.

In some examples, illumination of the touch object is intensity-modulated with a predetermined code. The modulation allows a higher signal-to-noise ratio of image data acquired by the device (e.g., by making it easier to identify this illumination in the acquired image data and/or to distinguish light reflected by the touch object from other light).

At step 1808, method 1800 optionally includes acquiring additional image data from a subset of microcameras located near the touch object(s). Image data from microcameras located away from the touch object(s) is generally not needed for performing touch-sensing functions. In some examples, step 1808 can be omitted (e.g., in situations in which only image data captured before the device switched into touch mode is needed).

In some examples, microcameras located away from the touch zone(s) can continue to acquire far-field image data while the microcameras in the touch zone(s) acquire image data for touch-sensing at step 1808.

In some examples, not all of the microcameras located near the touch object are used for acquiring data at step 1808, because this would provide a much higher resolution than is generally needed for touch-sensing functions. For example, data may be acquired from only every second or every third microcamera in the touch zone, from every tenth microcamera, and/or from any other suitable subset of microcameras. In some cases, it is sufficient to acquire image data from microcameras spaced from each other by several millimeters (e.g., a 4 to 6 millimeter pitch). Additionally, or alternatively, the image data sensed by each microcamera may be binned as a single image pixel, as the resolution provided by the multi-pixel photosensor of the microcamera is unnecessary.

At step 1812, method 1800 includes down-sampling and/or thresholding the acquired image data in any suitable manner to form a touch image. For example, the image data may be decimated (e.g., to simplify computation) and thresholded to form a touch image indicating the touch object. The touch image indicates the location of the touch object within an image frame, allowing the location of the touch object relative to the device, and/or to graphics displayed on the device, to be determined. Thresholding is used to filter out image capture noise in areas where there is no touch. Down-sampling image capture data to form the touch image reduces data processing requirements because the full microcamera resolution is not required for touch sensing.

At step 1816, method 1800 optionally includes formatting the touch image in a manner readable by an external device and/or software application configured to perform an action in response to the sensed touch object.

At step 1820, method 1800 optionally includes transmitting the touch image to an external device, such as a computer coupled to the display and image-capture device.

### O. Illustrative Fingerprint-Sensing Method

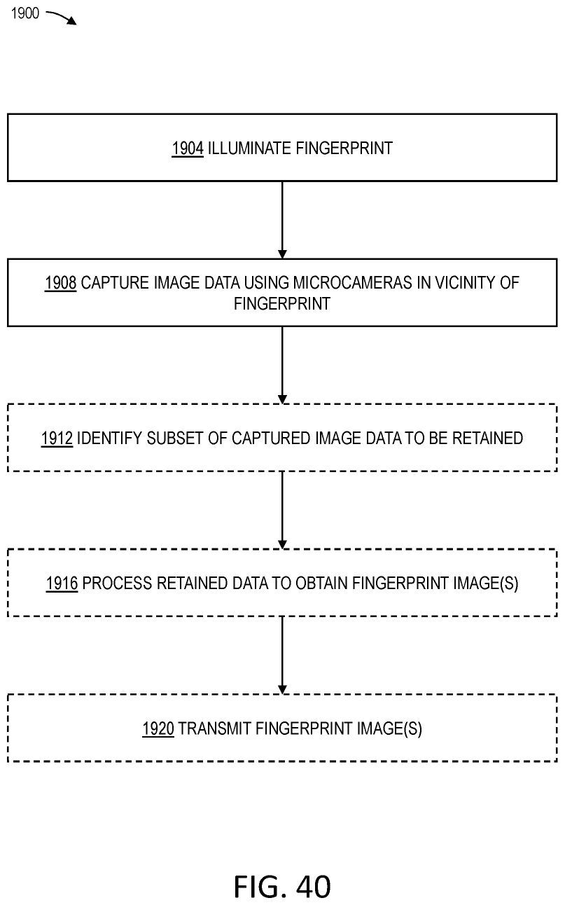

With reference to FIG. 40, this section describes an illustrative method 1900 for sensing a fingerprint of a digit touching and/or hovering over a display and image-capture device, in accordance with aspects of the present teachings. This may facilitate a biometric security function of the device. For example, certain functions of the device (e.g., far-field image capture) may be disabled until an authorized fingerprint is detected. As another example, recognition of a sensed fingerprint may allow a user to log in to one or more applications running on the device and/or on a computer in communication with the device.

Although method 1900 is described herein as enabling recognition of a fingerprint, the method may be utilized to recognize any suitable object contacting the display, or held near the display. For example, method 1900 may be utilized to enable recognition of a retina or other biometric identifier, an object having a bar code, quick response (QR) code or other suitable marker, and/or any other suitable object.

Aspects of display and image-capture devices and associated methods described elsewhere herein may be utilized in the method steps described below. Where appropriate, reference may be made to components and systems that may be used in carrying out each step. These references are for illustration, and are not intended to limit the possible ways of carrying out any particular step of the method.

Method 1900 may be similar in at least some respects to touch-sensing method 1800, described above. However, in at least some examples, image data is acquired according to method 1900 at a higher resolution than data acquired according to method 1800. For example, method 1800 may be used to detect the location of a stylus or other object, which does not require as high a resolution as imaging a fingerprint using method 1900. In some cases, method 1900 utilizes the full resolution of microcameras in the vicinity of the fingerprint (e.g., 500 dpi sensing and/or a 45-50 micron pixel pitch).

Method 1900 may be performed, e.g., in response to a command from an application executed by the display and image-capture device or by a computing device in communication with the display and image-capture device. For example, in response to being powered on or woken from a standby mode, the display and image-capture device (or computing device) may automatically execute a login application that prompts a user to touch an indicated region of the device using their finger.

At step 1904, method 1900 includes illuminating a fingerprint (e.g., a tip of a finger or thumb) touching or disposed adjacent the device, as described above with reference to method 1800. In some examples, the fingerprint is illuminated using infrared microLEDs (or LEDs), because infrared illumination may be especially suitable for satisfying biometric anti-spoofing requirements. In general, however, any suitable illumination may be used.

In some examples, the location of a finger may be determined using any suitable object-detection method (e.g., as described above with reference to method 1700). Any suitable number of infrared microLEDs in the vicinity of the sensed finger may be used to illuminate the fingerprint. Alternatively, or additionally, the general location of the finger may be predetermined (e.g., because an application executed by the device has indicated that a user should place their finger in a specific location). In this case, infrared microLEDs known to be in the vicinity of the predetermined location can be used to illuminate the fingerprint.

In some examples, the light generated at step 1904 by infrared microLEDs (or other suitable light emitters) and reflected off a sensed finger is collimated by suitable optical elements disposed within the display and image-capture device. The collimation facilitates the formation of an image (e.g., a substantially in-focus image) of the fingerprint on the photosensor of a microcamera near the infrared microLED in spite of the close proximity of the microcamera lens to the finger. Typically, the fingerprint is disposed just above the microcamera lens, too close for the lens to materially alter the image of the fingerprint. In some examples, the infrared microLED and/or associated collimating optics are disposed in the microcamera itself.

At step 1908, method 1900 includes capturing image data using one or more microcameras in the vicinity of the fingerprint. As described above, this image data is typically captured using the full resolution of this portion of the device, to facilitate recognition of small fingerprint features based on the captured image.

In some examples, step 1908 includes capturing image data in a depth-sensitive manner, enabling refocusing of images at a desired focal distance and/or depth of field. This may allow focused images to be produced of fingerprints disposed at a surface of the device (e.g., at a protective layer of the device). Alternatively, or additionally, the microcamera lenses used to capture image data at step 1908 may have electrically controllable lenses, and the device controller may be configured to control the lenses to focus on the fingerprint when capturing this image data.

At step 1912, method 1900 optionally includes identifying a subset of the captured image data that corresponds primarily to the fingerprint. In some cases, the spatial region for which image data is captured at step 1908 includes the fingerprint as well as the surrounding area. Only images corresponding to the actual fingerprint are typically needed for fingerprint recognition or similar functions. Accordingly, at step 1912, at least some image data not corresponding to the fingerprint can be discarded. Identifying a subset of image data to be retained may include, e.g., thresholding the captured image data to identify the specific location of the fingerprint and retaining only image data captured by microcameras disposed at or near that location.

At step 1916, method 1900 optionally includes performing image processing on the captured image data. This may include applying correction(s), enhancing resolution, refocusing the captured images, reducing noise, and/or performing any other suitable processes to achieve one or more fingerprint images having desired properties (e.g., a desired image resolution). This step may be performed using a controller of the device and/or a computer coupled to the device and executing a fingerprint-recognition program, as appropriate.

At step 1920, method 1900 optionally includes transmitting the fingerprint image(s) to another device for biometric evaluation. The device could be a local computer connected to the display and image-capture device and/or a remote computer in communication with the device via a network. For example, the device could be configured to automatically compare the fingerprint image(s) to a reference fingerprint, or to facilitate a user to compare the fingerprint image(s) to a reference fingerprint.

### P. Illustrative Videoconferencing Examples

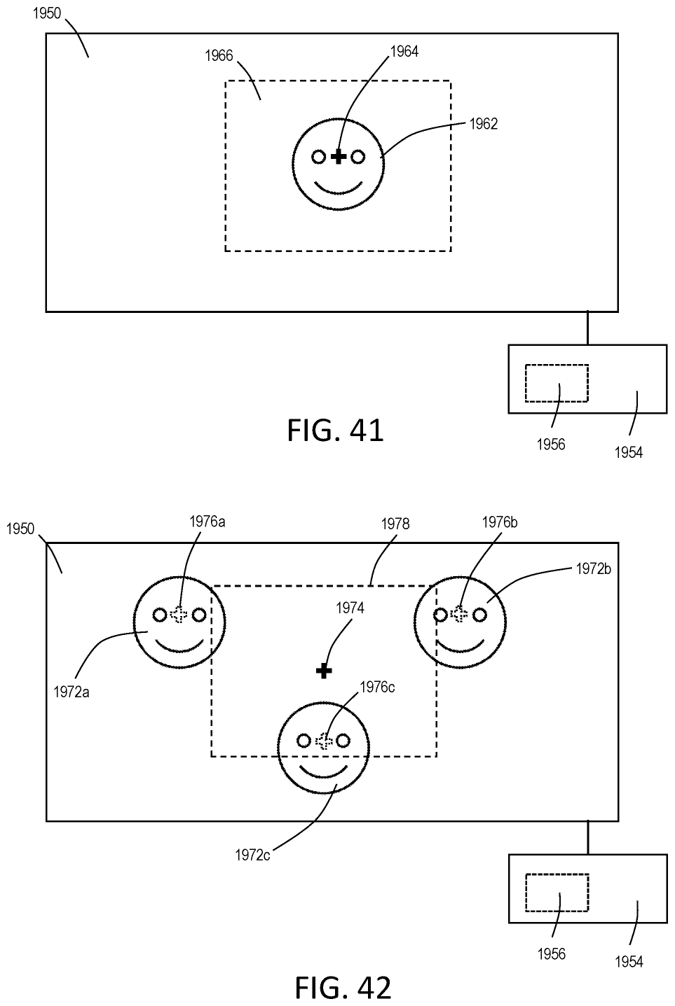

With reference to FIGS. 41-44, this section describes illustrative methods for videoconferencing, including selectively capturing image data using a selected region of the display and image-capture device in a manner that reduces or eliminates gaze parallax. Gaze parallax can arise in videoconferencing using known devices, especially when using a larger display such as devices used for desktop monitors and meeting room displays, because the center of a camera located at the top, bottom or side of a display is far from the displayed eyes of the remote participants. Excessive gaze parallax disrupts the feeling of connection between meeting participants, and it is therefore desirable to minimize gaze parallax.

FIG. 41 depicts an example wherein an illustrative display and image-capture device 1950 is in communication with a computer 1954 executing a videoconferencing application 1956. Computer 1954 may comprise any data processing system suitable for executing the videoconferencing application, such as a personal computer, laptop computer, tablet, smartphone, and/or other suitable device. Device 1950 and computer 1954 may be in communication via a wired connection, a wireless connection, one or more networks, and/or any other suitable manner.

Computer 1954 is configured to provide to device 1950 a video image (e.g., a video stream received from another device via the videoconferencing application, a video image comprising a graphical user interface of the computer, and/or any other suitable image), and to receive from device 1950 a live video capture stream captured by device 1950. In some examples, computer 1954 is further configured to provide to an electronic controller of device 1950 (e.g., controller 1500, described above) video formatting signal(s) such as a desired camera field of view chief axis (e.g. an active speaker direction), zoom ratio, coordinates of remote participant windows, faces, and eyes, etc. In response to receiving the video formatting signals, the device controller provides live video images to computer 1954 in the requested video stream format.

Computer 1954 is configured to indicate to a controller of device 1950 one or more regions of the device to be used to capture images (e.g., virtual camera locations). The virtual camera locations can be selected in a manner that reduces or eliminates gaze parallax. For example, computer 1954 may be configured to identify one or more regions of device 1950 on which device 1950 is displaying received video images of teleconference participants. Computer 1954 communicates information indicating the identified regions, and/or portions of the identified regions, to device 1950. In response to the received information, device 1950 captures ambient image data using the identified regions (or portions of regions) of the device. Local user(s) of device 1950 are typically looking at the identified region(s) of the device (because the video images of the remote user(s) are displayed there), so gaze parallax is reduced or eliminated. The virtual camera locations may be provided to device 1950 by computer 1954 along with any other video formatting data.

The device controller may determine, based on the indicated virtual camera location(s), which microcameras to activate and/or from which microcameras to obtain image data, how many distinct video streams to reconstruct from the selected microcamera images, and how to format the video stream(s). For example, if computer 1954 indicates that two distinct regions of the device should be used to capture images, the device controller may format and transmit images captured from the two regions in two video streams. This may facilitate use of the video streams in videoconferencing application 1956.

In the example depicted in FIG. 41, device 1950 receives and displays video images of a remote videoconference participant 1962. Computer 1954 is configured to identify location(s) on device 1950 corresponding to a suitable portion of participant 1962 (e.g., their eye(s), between their eyes, their face or head or a center of their face or head, and/or any other suitable portion). In the depicted example, computer 1954 identifies a location 1964 between the participant's eyes. The identified location is sent to the device controller, which captures video images using microcameras in a region 1966 in the vicinity of the identified location. The size of region 1966 may be determined in any suitable manner. Device 1950 may format the video stream to be sent to the remote participant.

FIG. 42 depicts an example wherein a plurality of remote participants 1972a, 1972b, 1972c are displayed on device 1900. This may be the case if, for example, device 1900 receives a respective video stream from each remote participant (e.g., because they are each participating via their own videoconferencing device), and each video stream is displayed in a separate region of the device (e.g., in a separate window). Alternatively, two or more of remote participants 1972a, 1972b, 1972c may appear together on a same video stream (e.g., because they are participating via the same videoconferencing device).

Computer 1954 identifies a virtual camera position 1974 that accounts for gaze parallax for all remote participants. For example, position 1974 may comprise a position that minimizes gaze parallax for all remote participants. In some examples, position 1974 comprises a geometric center of locations 1976a, 1976b, 1976c between the eyes of participants 1972a, 1972b, and 1972c respectively. However, in some examples, position 1974 is not selected to reduce gaze parallax for all remote participants equally. For example, selection of position 1974 may favor one of the participants (for example, a participant who is speaking). Device 1950 captures image data using microcameras disposed in a region 1978 that includes position 1974 (e.g., with position 1974 at the center of the image-capturing region). This image data can be transmitted to the remote participants.

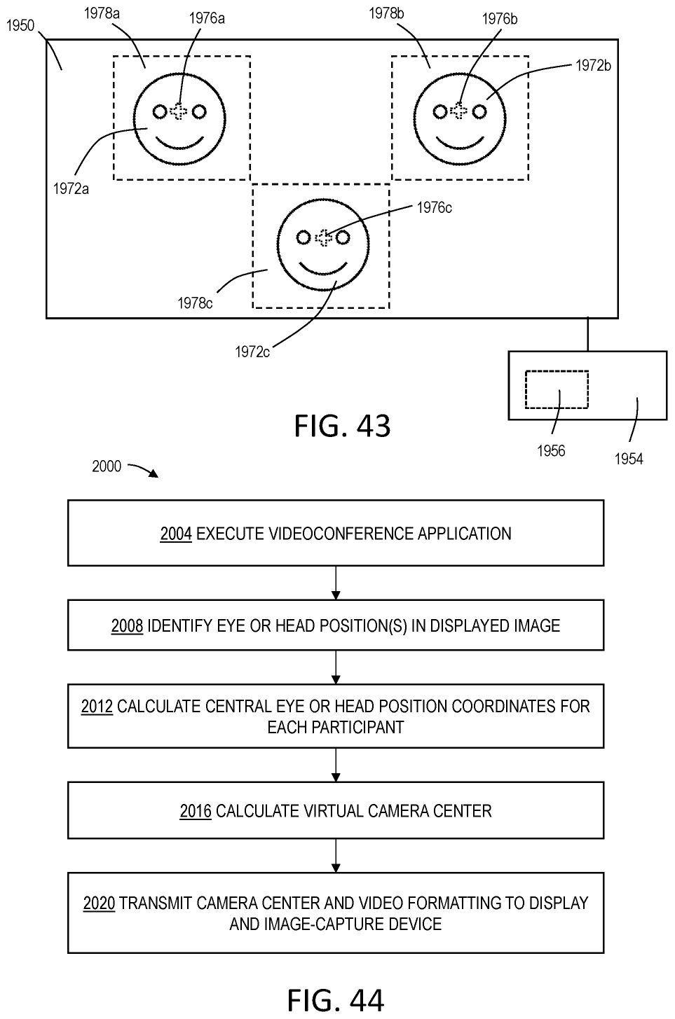

Alternatively, or additionally, device 1950 may be configured to capture separate video streams corresponding to each remote participant. This may be the case, for example, if each remote participant displayed on the device is participating using their own videoconferencing device. As shown in FIG. 43, device 1900 may be configured to capture image data from each of regions 1978a, 1978b, 1978c corresponding to locations 1976a, 1976b, 1976c respectively. The device controller selects the appropriate microcameras and image reconstruction method(s) to produce and output three simultaneous and separate video streams according to the plurality of virtual camera center locations. Each video stream can be sent to the corresponding remote participant. This allows gaze parallax to be reduced for whichever remote participant the device user is looking at.

FIG. 44 is a flowchart illustrating steps performed in an illustrative method 2000 for videoconferencing, and may not recite the complete process or all steps of the method. Although various steps of method 2000 are described below and depicted in FIG. 44, the steps need not necessarily all be performed, and in some cases may be performed simultaneously or in a different order than the order shown.

At step 2004, method 2000 includes executing a video conference application on a computing device (e.g., a computer, smartphone, and/or any other suitable data processing system) in communication (e.g., via network(s), wired connections, wireless connections, and/or any other suitable connection) with a display and image-capture device.

Steps 2008-2020 are typically performed by the computing device executing the application. At step 2008, method 2000 includes identifying position(s) of eyes, heads, and/or any other suitable portion of one or more participants in one or more images displayed on the display and image-capture device. These positions may be identified using any suitable process (e.g., image-recognition algorithms, machine learning, neural networks, and/or any other suitable process). The displayed images are received by the computing device executing the videoconference application, and transmitted from the computing device to the display and image-capture device.

At step 2012, method 2000 includes calculating, for each participant displayed on the device, position coordinates indicating a spatial location on the display device where the participant's head (e.g., their eyes, a space between their eyes, etc.) appears.

At step 2016, method 2000 includes determining, based on the calculated position coordinates, a suitable location for a virtual camera center (i.e., a center of a region of the device to be used to capture image data).

At step 2020, method 2000 includes communicating the identified virtual camera center location to the display and image-capture device (e.g., to a controller of the device), so that the device can capture images from a region of the device including the virtual camera center (e.g., with the virtual camera center at the center of image-capture region). Video formatting information may be communicated to the device along with the center location.

### Q. Illustrative Combinations and Additional Examples

This section describes additional aspects and features of display and image-capture devices, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A device comprising a substrate generally defining a plane; a plurality of electrical conductors disposed on the substrate; a plurality of image sensor dies disposed on the substrate, each image sensor die including a photosensor region; a plurality of light emitting dies disposed on the substrate, each light emitting die including a light emitting region; at least one electronic controller configured, through the electrical conductors, to transmit mode signals to the image sensor dies, receive image data from the image sensor dies, and transmit display signals to the light emitting dies; and a power source configured, through the electrical conductors, to provide the power to the image sensor dies and the light emitting dies.

A1. The device of paragraph A0, further comprising a plurality of microlenses disposed in a microlens array layer on a light-incident side of the image sensor dies, wherein each microlens is configured to focus incident light on an associated one of the photosensor regions.

A2. The device of paragraph A1, further comprising a field stop layer disposed between the microlens array layer and the image sensor dies, wherein the field stop layer includes a patterned mask configured to prevent light focused by each microlens from reaching any of the photosensor regions other than the photosensor region associated with each microlens.

A3. The device of any one of paragraphs A0 through A2, wherein the light emitting regions each include a microLED.

A4. The device of any one of paragraphs A0 through A3, wherein each photosensor region includes a plurality of image sensing pixels arranged in a two-dimensional array.

A5. The device of paragraph A4, wherein each image sensor die includes a processing circuit configured to receive image data from the photosensor region, to process the image data received from the photosensor region, and to transmit the processed image data to the electronic controller.

A6. The device of paragraph A5, wherein the processing circuits of the image sensing dies are configured to receive commands from the controller, including commands to switch image sensing modes.

A7. The device of any one of paragraphs A5 through A6, wherein the processing circuits of the image sensing dies are configured, in response to a signal received from the controller, to process and transmit image data corresponding only to a subset of the image sensing pixels of the image sensing die associated with each processing circuit.

A8. The device of paragraph A7, wherein the subset of the image sensing pixels depends on a location of the associated image sensing die on the substrate.

A9. The device of any one of paragraphs A0 through A8, wherein the substrate is a monitor display screen.

B0. A device comprising a substrate generally defining a plane; a plurality of image sensor dies disposed on the substrate, each image sensor die including a photosensor region; a plurality of lenses disposed on a light-incident side of the image sensor dies, wherein each of the lenses is configured to direct light impinging on a front surface of the lens toward a predetermined one of the photosensor regions based on an angle of incidence between the impinging light and the front surface of the lens; a plurality of light emitting dies disposed on the substrate, each light emitting die including a light emitting region; and at least one electronic controller configured to transmit mode information to the image sensor dies, receive image data from the image sensor dies, and transmit display signals to the light emitting dies.

B1. The device of paragraph B0, wherein each photosensor region includes a two-dimensional array of image sensing pixels and wherein each image sensor die includes a processing circuit configured to receive image data from the pixels, to process the image data, and to transmit the processed image data to the electronic controller.

B2. The device of paragraph B1, wherein the processing circuits are configured to switch image sensing modes based on a signal received from the controller.

B3. The device of any one of paragraphs B1 through B2, wherein the processing circuit of each image sensor die is configured to selectively process and transmit image data corresponding only to a subset of the pixels of the image sensing die, based on a signal received from the controller.

B4. The device of paragraph B3, wherein the subset of the image sensing pixels depends on a location of the associated image sensing die on the substrate.

B5. The device of any one of paragraphs B0 through B4, further comprising a plurality of microlenses including one microlens disposed on a light-incident side of each image sensor die and configured to focus incident light on the photosensor region of the image sensor die.

B6. The device of paragraph B5, further comprising a field stop layer disposed between the microlenses and the image sensor dies, wherein the field stop layer is configured to inhibit light focused by each microlens from reaching more than one photosensor region.

C0. A camera display system comprising a substrate generally defining a plane; a plurality of micro-cameras disposed on the substrate, each of the micro-cameras including an image sensor and a lens configured to direct incident light onto the image sensor; an array of light-emitting elements disposed on the substrate; a substantially optically transparent protective layer overlying the micro-cameras and the light-emitting elements; and at least one electronic controller configured to receive image data from the incident light and transmit display signals to the light-emitting elements.

C1. The system of paragraph C0, wherein the lenses are aspheric, and wherein each lens has a surface profile which depends on a distance of the lens from a central point of the substrate.

C2. The system of any one of paragraphs C0 through C1, wherein the camera display system is a touch-sensitive monitor display.

D0. A device comprising a substrate generally defining a plane; a plurality of electrical conductors disposed on the substrate; a plurality of image sensor dies disposed on the substrate, each image sensor die including a photosensor region; a plurality of light emitting dies disposed on the substrate, each light emitting die including a light emitting region; at least one electronic controller configured, through the electrical conductors, to receive image data from the image sensor dies and transmit display signals to the light emitting dies; and a power source configured, through the electrical conductors, to provide the power to the image sensor dies and the light emitting dies.

D1. The device of paragraph D0, further comprising a plurality of microlenses disposed in a microlens array layer on a light-incident side of the image sensor dies, wherein each microlens is configured to focus incident light on an associated one of the photosensor regions.

D2. The device of paragraph D1, further comprising a field stop layer disposed between the microlens array layer and the image sensor dies, wherein the field stop layer includes a patterned mask configured to prevent light focused by each microlens from reaching any of the photosensor regions other than the photosensor region associated with each microlens.

D3. The device of any one of paragraphs D0 through D2, wherein the at least one electronic controller is configured to cause the image data to be processed according to a selected mode of operation of the device.

D4. The device of any one of paragraphs D0 through D3, wherein each photosensor region includes a plurality of image sensing pixels arranged in a two-dimensional array.

D5. The device of any one of paragraphs D0 through D4, wherein each image sensor die includes a processing circuit configured to receive image data from the photosensor region, to process the image data received from the photosensor region, and to transmit the processed image data to the electronic controller.

D6. The device of paragraph D5, wherein the processing circuits of the image sensing dies are configured to process the image data received from the photosensor regions into resolution-enhanced images, based on overlapping fields of view of the photosensor regions.

D7. The device of any one of paragraphs D5 through D6, wherein the processing circuits of the image sensing dies are configured to process the image data received from the photosensor regions into resolution-enhanced images using a super-resolution technique.

D8. The device of any one of paragraphs D5 through D7, wherein the processing circuits of the image sensing dies are configured to process the image data received from the photosensor regions into resolution-enhanced images using deconvolution techniques.

D9. The device of any one of paragraphs D0 through D8, wherein the substrate is a monitor display screen or a mobile device display screen.

E0. A device comprising a substrate generally defining a plane; a plurality of image sensor dies disposed on the substrate, each image sensor die including a photosensor region; a plurality of lenses disposed on a light-incident side of the image sensor dies, wherein each of the lenses is configured to direct light impinging on a front surface of the lens toward a predetermined one of the photosensor regions based on an angle of incidence between the impinging light and the front surface of the lens; a plurality of light emitting dies disposed on the substrate, each light emitting die including a light emitting region; and at least one electronic controller configured to receive image data from the image sensor dies and transmit display signals to the light emitting dies.

E1. The device of paragraph E0, wherein each photosensor region includes a two-dimensional array of image sensing pixels and further comprising one or more processing circuits configured to receive image data from the pixels, to process the image data, and to transmit the processed image data to the electronic controller.

E2. The device of paragraph E1, wherein the one or more processing circuits are configured to switch image sensing modes based on a signal received from the controller.

E3. The device of any one of paragraphs E1 through E2, wherein the one or more processing circuits are configured to selectively process and transmit image data corresponding only to a subset of the pixels of each image sensing die, based on a signal received from the controller.

E4. The device of any one of paragraphs E0 through E3, wherein the substrate is a display screen of a monitor, television, mobile device, tablet, or interactive display.

E5. The device of any one of paragraphs E0 through E4, further comprising a plurality of microlenses, including one microlens disposed on a light-incident side of each image sensor die and configured to focus incident light on the photosensor region of the image sensor die.

F0. A camera display system comprising a substrate generally defining a plane; a plurality of micro-cameras disposed on the substrate, each of the micro-cameras including an image sensor and a lens configured to direct incident light onto the image sensor; an array of light-emitting elements disposed on the substrate; and at least one electronic controller configured to receive image data from the micro-cameras and transmit display signals to one or more transistors to regulate current flow to the light-emitting elements, wherein said display signals configured to cause light-emitting region to emit light with selected intensity and color.

F1. The system of paragraph F0, wherein the micro-cameras have overlapping fields of view, and the electronic controller is configured to transmit resolution-enhanced display signals generated from the image data based on the overlapping fields of view.

F2. The system of any one of paragraphs F0 through F1, wherein the camera display system functions as a touch-sensitive display of a mobile device, computer, television, tablet, or interactive display.

F3. The system of any one of paragraphs F0 through F2, wherein the electronic controller is configured to process the image data received from the micro-cameras into a resolution-enhanced image using a super-resolution technique.

G0. A method for capturing video image data, comprising providing a plurality of image-sensing devices and a plurality of display pixels all embedded in a panel; receiving image display signals at the display pixels; displaying a first video image with at least a first subset of the display pixels based on the received image display signals; capturing ambient image data with the plurality of image-sensing devices; generating corrected image data by applying a correction to the captured ambient image data; receiving the corrected image data at an electronic controller; and constructing a second video image from the corrected image data with the electronic controller.

G1. The method of paragraph G0, wherein the image-sensing devices and the display pixels embedded in the panel are disposed on a substrate of the panel.

G2. The method of paragraph G0, wherein the image-sensing devices and the display pixels embedded in the panel are comprised by one or more thin-film circuitry layers of the panel.

G3. The method of any one of paragraphs G0 through G2, further comprising displaying the second video image with a second subset of the display pixels.

G4. The method of any one of paragraphs G0 through G3, wherein displaying the first video image is performed simultaneously with capturing the ambient image data.

G5. The method of any one of paragraphs G0 through G3, wherein displaying the first video image and capturing the ambient image data are performed in alternating fashion at a frequency of at least 30 Hertz.

G6. The method of any one of paragraphs G0 through G5, wherein the ambient image data includes reference object image data captured from a reference object, and further comprising determining the correction from the reference object image data.

G7. The method of any one of paragraphs G0 through G6, wherein the image-sensing devices are microcameras, and the correction is applied to the ambient image data captured by each microcamera using a separate processing circuit disposed adjacent each microcamera.

H0. A method for capturing video image data, comprising providing an image-capture and display device which includes a plurality of image-sensing devices and a plurality of display pixels disposed in a common panel; capturing image data with the plurality of image-sensing devices; receiving the image data at an electronic controller; constructing a high-resolution image frame from the image data with the electronic controller; and repeating the steps of capturing image data, receiving the image data at the electronic controller, and constructing a high-resolution image frame from the image data with the electronic controller, to obtain a succession of high-resolution image frames.

H1. The method of paragraph H0, further comprising applying a nonuniformity correction to the captured image data before constructing each high-resolution image frame.

H2. The method of paragraph H1, further comprising capturing reference object image data from a reference object with the plurality of image-sensing devices, constructing reference images from the reference object image data, and determining the nonuniformity correction based on the reference images.

H3. The method of any one of paragraphs H1 through H2, wherein the image-sensing devices are microcameras, and the nonuniformity correction is applied to the image data captured by each microcamera using a processing circuit disposed at or adjacent the microcamera.

H4. The method of any one of paragraphs H0 through H3, wherein the image-sensing devices are microcameras, and further comprising compressing the image data captured by each microcamera using a processing circuit disposed at or adjacent the microcamera.

H5. The method of paragraph H4, further comprising decompressing the image data using the electronic controller.

H6. The method of any one of paragraphs H0 through H5, further comprising checking for presence of an object touching or hovering over the display and image-capture device using the electronic controller, and in response to detecting such an object, switching at least a portion of the display and image-capture device to a touch-sensing mode of operation.

J0. A method for capturing video image data, comprising providing an image-capture and display device which includes a plurality of microcameras and a plurality of display pixels all disposed in a common display panel; capturing image data with the microcameras; correcting the image data by applying a correction to the image data captured by each microcamera; receiving the image data at an electronic controller; constructing a high-resolution image frame from the corrected image data with the electronic controller; repeating the steps of capturing image data, correcting the image data, receiving the image data at the electronic controller, and constructing a high-resolution image frame from the corrected image data with the electronic controller, to obtain a succession of high-resolution image frames; and displaying an image on the device with the display pixels.

J1. The method of paragraph J0, wherein displaying the image on the device is performed simultaneously with capturing the image data.

J2. The method of paragraph J0, wherein displaying the image on the device is alternated with capturing the image data at a frequency sufficient to avoid noticeable flicker in the displayed image.

J3. The method of any one of paragraphs J0 through J2, wherein the image data includes reference object image data captured from a reference object, and further comprising determining the n correction from the reference object image data.

J4. The method of any one of paragraphs J0 through J3, wherein the correction is applied to the image data captured by each microcamera using a processing circuit disposed at or adjacent the microcamera.

J5. The method of any one of paragraphs J0 through J4, further comprising compressing the image data captured by each microcamera using a processing circuit disposed at or adjacent the microcamera, and decompressing the image data using the electronic controller.

J6. The method of any one of paragraphs J0 through J5, further comprising checking for presence of an object touching or hovering over the display and image-capture device using the electronic controller, and in response to detecting such an object, switching at least a portion of the device to a touch-sensing mode of operation.

### Advantages, Features, and Benefits

The different embodiments and examples of the display and image-capture device described herein provide several advantages over known solutions for providing display and image-capture functions on the same device. For example, illustrative embodiments and examples described herein allow for videoconferencing with reduced gaze parallax, and/or substantially without gaze parallax.

Additionally, and among other benefits, illustrative embodiments and examples described herein allow for an image-capture system having a field of view, effective aperture size, focal distance, and depth of focus that are programmatically adjustable. Accordingly, these properties can be adjusted to suit a particular application and/or location by software commands, rather than changes to hardware.

Additionally, and among other benefits, illustrative embodiments and examples described herein allow for an image-capture and display device in which the light-emitting dies that comprise display pixels occupy only a small fraction of the area of the device (relative to known devices). Accordingly, the device has more room for image sensors and/or other devices. The device display also has higher contrast due to the increased space between display pixels.

Additionally, and among other benefits, illustrative embodiments and examples described herein allow a plenoptic camera having no objective lens. For example, the plenoptic camera can be a flat-panel camera.

Additionally, and among other benefits, illustrative embodiments and examples described herein allow for a flexible flat-panel camera and display device. The flexible flat-panel form factor allows the device to be stored and transported more easily. This may allow for a device that is larger than existing rigid camera and display devices. For example, the size of rigid devices is typically limited by the need to fit into an elevator, whereas flexible embodiments described herein may be rolled to fit into an elevator and/or other small space. For at least this reason, illustrative embodiments and examples described herein allow for a display and image-capture device that is larger than known devices.

Additionally, and among other benefits, illustrative embodiments and examples described herein allow for an image-capture and display device that is lighter in weight and consumes less power than known devices.

Additionally, and among other benefits, illustrative embodiments and examples described herein allow for an image-capture and display device that can be manufactured in according to cost-effective methods. For example, the image-sensor dies and/or light-emitting dies may be attached to and/or formed on the substrate using cost-effective roll-based transfer technology.

No known system or device can perform these functions. However, not all embodiments and examples described herein provide the same advantages or the same degree of advantage.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method for capturing video image data, comprising:
receiving image display signals at a plurality of display pixels embedded in a panel, wherein the plurality of display pixels are disposed on a first circuitry layer adjacent a light-incident side of a transparent substrate of the panel;
displaying a first video image with at least a first subset of the display pixels based on the received image display signals;
capturing ambient image data using a plurality of image-sensing devices disposed on a second circuitry layer adjacent a back side of the transparent substrate of the panel; and
constructing a second video image from the ambient image data.

2. The method of claim 1, further comprising displaying the second video image with a second subset of the display pixels.

3. The method of claim 1, wherein displaying the first video image is performed simultaneously with capturing the ambient image data.

4. The method of claim 1, wherein displaying the first video image and capturing the ambient image data are performed in alternating fashion at a frequency of at least 30 Hertz.

5. The method of claim 1, wherein the ambient image data includes reference object image data captured from a reference object, and further comprising determining a correction from the reference object image data.

6. The method of claim 1, wherein the image-sensing devices are microcameras, the method further comprising generating corrected image data by applying a correction to the captured ambient image data, wherein the correction is applied to the ambient image data captured by each microcamera using a separate processing circuit disposed adjacent each microcamera.

7. A method for capturing video image data, comprising:
capturing image data using a plurality of image-sensing devices embedded in a panel including a transparent substrate, wherein a plurality of display pixels embedded in the panel are disposed on a first circuitry layer adjacent a light-incident side of the transparent substrate, and wherein the image-sensing devices are disposed on a second circuitry layer adjacent a back side of the transparent substrate;
constructing a high-resolution image frame from the image data using an electronic controller; and
repeating the steps of capturing image data and constructing a high-resolution image frame from the image data with the electronic controller, to obtain a succession of high-resolution image frames.

8. The method of claim 7, further comprising applying a nonuniformity correction to the captured image data before constructing each high-resolution image frame.

9. The method of claim 8, further comprising capturing reference object image data from a reference object with the plurality of image-sensing devices, constructing reference images from the reference object image data, and determining the nonuniformity correction based on the reference images.

10. The method of claim 8, wherein the image-sensing devices are microcameras, and the nonuniformity correction is applied to the image data captured by each microcamera using a processing circuit disposed at or adjacent the microcamera.

11. The method of claim 7, wherein the image-sensing devices are microcameras, and further comprising compressing the image data captured by each microcamera using a processing circuit disposed at or adjacent the microcamera.

12. The method of claim 11, further comprising decompressing the image data using the electronic controller.

13. The method of claim 7, further comprising checking for presence of an object touching or hovering over the light-incident side of the panel using the electronic controller, and in response to detecting such an object, switching at least a portion of the display pixels and image sensing devices to a touch-sensing mode of operation.

14. A method for capturing video image data, comprising:
capturing image data using a plurality of microcameras embedded in a panel of a device, the panel including a transparent substrate, wherein a plurality of display pixels embedded in the panel are disposed on a first circuitry layer adjacent a light-incident side of the transparent substrate, and wherein the microcameras are disposed on a second circuitry layer adjacent a back side of the transparent substrate;
correcting the image data by applying a correction to the image data captured by each microcamera;
constructing a high-resolution image frame from the corrected image data;
repeating the steps of capturing image data, correcting the image data, and constructing a high-resolution image frame from the corrected image data, to obtain a succession of high-resolution image frames; and
displaying a succession of high-resolution image frames on the device using the display pixels.

15. The method of claim 14, wherein displaying the image on the device is performed simultaneously with capturing the image data.

16. The method of claim 14, wherein displaying the image on the device is alternated with capturing the image data at a frequency sufficient to avoid noticeable flicker in the displayed image.

17. The method of claim 14, wherein the image data includes reference object image data captured from a reference object, and further comprising determining the correction from the reference object image data.

18. The method of claim 17, wherein the correction is applied to the image data captured by each microcamera using a processing circuit disposed at or adjacent the microcamera.

19. (canceled)

20. The method of claim 14, further comprising checking for presence of an object touching or hovering over the display and image-capture device, and in response to detecting such an object, automatically switching at least a portion of the device to a touch-sensing mode of operation.

21. The method of claim 7, further comprising displaying the succession of high-resolution image frames on the panel using the display pixels.
